(19) United States
(12) Patent Application Publication
(10) Pub. No.: US 2024/0403814 A1
(43) Pub. Date: Dec. 5, 2024

(54) INFORMATION PROCESSING SYSTEM AND METHOD OF INFORMATION PROCESSING

(71) Applicant: FRONTEO, Inc., Tokyo (JP)

(72) Inventors: Yuichi KICHIKAWA, Tokyo (JP); Toru HISAMITSU, Tokyo (JP)

(21) Appl. No.: 18/674,305

(22) Filed: May 24, 2024

(30) Foreign Application Priority Data
Jun. 1, 2023 (JP) 2023-091206

(51) Int. Cl. G06Q 10/0835; G06Q 10/0639

(52) U.S. Cl. CPC G06Q 10/0835; G06Q 10/06395

(57) ABSTRACT

An information processing system includes: a trading network obtaining unit configured to obtain a trading network in which a plurality of nodes are connected together by an edge indicating a trading relationship; a vector obtaining unit configured to select any one of the plurality of nodes as a vector-calculation target node, and to determine, for each of the plurality of nodes, a complex vector by assigning a complex number, a supply chain extracting unit configured to extract a supply chain network in accordance with the complex vector indicating each of the plurality of nodes, the supply chain network being a part of the trading network; and a tag-transition-diagram generating unit configured to generate a tag transition diagram in accordance with a tag given to nodes included in the supply chain network of the plurality of nodes, the tag transition diagram showing information about the tag in the supply chain network.

### CROSS-REFERENCE TO RELATED APPLICATION

The present application claims priority from Japanese Application JP 2023-091206, filed Jun. 1, 2023, the content of which is hereby incorporated by reference into this application.

### BACKGROUND OF THE INVENTION

### 1. Field of the Invention

The present invention relates to, but not limited to, an information processing system and a method of information processing.

### 2. Description of the Related Art

Various conventional techniques are known for supply chain analysis. A supply chain is a series of flow starting from the procurement of the raw materials and components of a product to the manufacture, inventory management, delivery, sale and consumption of the product.

For instance, Japanese Patent No. 7034447 discloses an information processing system that analyzes, in a supply chain, a subnetwork including at least one of upstream and downstream subnetworks of a company of interest, and that displays the analysis result. Further, Takayuki Mizuno, Takaaki Ohnishi, Tsutomu Watanabe, “Structure of global buyer-supplier networks and its implications for conflict minerals regulations” EPJ Data Science, published on Jan. 16, 2016, (URL: https://doi.org/10.1140/epjds/s13688-016-0063-7) discloses a technique of extracting a company with high relevance through a community breakdown technique.

### SUMMARY OF THE INVENTION

For example, if a target company is connected to a company having dealings with the target company on the basis of open information or other things to thus generate a trading network, the trading network accidentally includes a trading chain to which the target company does not directly pertain. Conventional methods, such as that disclosed in Japanese Patent No. 7034447, are not directed to extracting a network (supply chain network) directly pertaining to the target company from the trading network, and providing the overview of the supply chain network in an easy-to-understand manner.

Some aspects of the present disclosure can provide, but not limited to, an information processing system and a method of information processing that present the overview of a supply chain network in an easy-to-understand manner.

One aspect of the present disclosure is directed to an information processing system including the following: a trading network obtaining unit configured to obtain a trading network in which a plurality of nodes corresponding one-to-one to a plurality of companies are connected together by an edge indicating a trading relationship; a vector obtaining unit configured to select any one of the plurality of nodes as a vector-calculation target node, and to determine, for each of the plurality of nodes, a complex vector by assigning a complex number, the complex vector representing a relationship of the vector-calculation target node with another one of the plurality of nodes, the complex number having a phase corresponding to a distance to the vector-calculation target node, and an absolute value corresponding to an amount of flow going to or coming from the vector-calculation target node; a supply chain extracting unit configured to extract a supply chain network in accordance with the complex vector indicating each of the plurality of nodes, the supply chain network being a part of the trading network; and a tag-transition-diagram generating unit configured to generate a tag transition diagram in accordance with a tag given to nodes included in the supply chain network of the plurality of nodes, the tag transition diagram showing information about the tag in the supply chain network.

Another aspect of the present disclosure is directed to a method of information processing that is performed by an information processing system. The method includes the following: obtaining a trading network in which a plurality of nodes corresponding one-to-one to a plurality of companies are connected together by an edge indicating a trading relationship; selecting any one of the plurality of nodes as a vector-calculation target node, and determining, for each of the plurality of nodes, a complex vector by assigning a complex number, the complex vector representing a relationship of the vector-calculation target node with another one of the plurality of nodes, the complex number having a phase corresponding to a distance to the vector-calculation target node, and an absolute value corresponding to an amount of flow going to or coming from the vector-calculation target node; extracting a supply chain network in accordance with the complex vector indicating each of the plurality of nodes, the supply chain network being a part of the trading network; and generating a tag transition diagram in accordance with a tag given to nodes included in the supply chain network of the plurality of nodes, the tag transition diagram showing information about the tag in the supply chain network.

### BRIEF DESCRIPTION OF THE DRAWINGS

FIG. 1 illustrates an example of the configuration of a system including an information processing system according to an embodiment;

FIG. 2 is a functional block diagram illustrating an example of the detailed configuration of a server system;

FIG. 3 is a functional block diagram illustrating an example of the detailed configuration of a terminal device;

FIG. 4 is a flowchart schematically showing processing that is executed in the information processing system;

FIG. 5A is an example of the structure of data that is obtained in accordance with open information;

FIG. 5B illustrates an example of the structure of the data that is obtained in accordance with the open information;

FIG. 5C illustrates an example of part of a trading network that is obtained in accordance with the open information;

FIG. 6 is a schematic diagram illustrating the trading network;

FIG. 7 is a flowchart showing processing to determine a vectorial representation;

FIG. 8 is a flowchart showing processing to extract an upstream trading subnetwork;

FIG. 9A illustrates an example of part of a trading subnetwork;

FIG. 9B illustrates an example of part of the trading subnetwork;

FIG. 10 illustrates an example of the trading subnetwork;

FIG. 11A is a flowchart showing processing to determine the vectorial representation of a node;

FIG. 11B is a flowchart showing processing to determine the vectorial representation of the node;

FIG. 12A illustrates an example of flow amounts in the trading subnetwork;

FIG. 12B illustrates an example of with-phase flow amounts in the trading subnetwork;

FIG. 13 illustrates an example of a complex vector corresponding to a given node;

FIG. 14 illustrates an example of with-phase flow amounts in the trading subnetwork;

FIG. 15 is a flowchart showing first extraction processing on a supply chain network;

FIG. 16 is a flowchart showing second extraction processing on the supply chain network;

FIG. 17 illustrates an example of the trading network, and an example of the tag of each node;

FIG. 18 is a table showing the relationship between node transition and weight;

FIG. 19 illustrates an example of the weight (flow amount) of each node in the trading network in FIG. 17;

FIG. 20 is a table showing the relationship between tag transition pattern and weight;

FIG. 21 is a table showing the relationship between adjacent-tag transition pattern and weight;

FIG. 22 is an example of a Sankey diagram, which is a tag transition diagram; and FIG. 23 illustrates an example of a subnetwork that is extracted by a selected transition pattern.

### DETAILED DESCRIPTION OF THE INVENTION

An embodiment will be described with reference to the drawings. Identical or equivalent constituents will be denoted by the same signs throughout the drawings, and redundant descriptions related to the identical or equivalent constituents, if any, will be omitted as appropriate. It is noted that the embodiment that will be described below shall not limit what are recited in the claims. It is also noted that all configurations that will be described in the embodiment are not necessarily essential components of the present disclosure. As long as functions that will be described in the present disclosure are carried out, the configurations that will be described in the embodiment may be omitted as appropriate.

### 1. Example of System Configuration

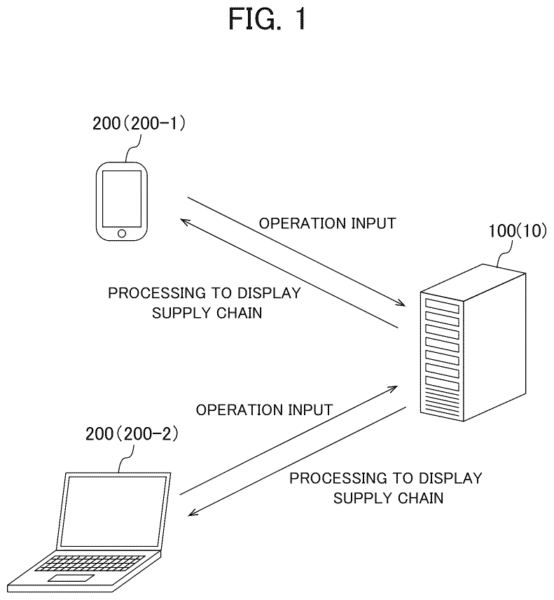

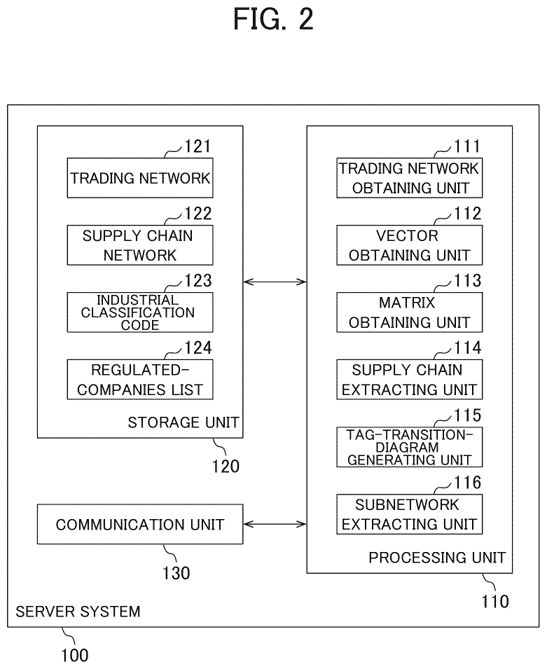

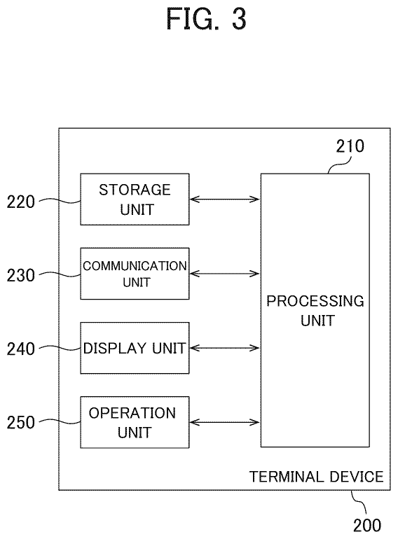

FIG. 1 illustrates an example of the configuration of a system including an information processing system 10 according to an embodiment. The system according to this embodiment includes a server system 100, and a terminal device 200. It is noted that the configuration of the system including the information processing system 10 shall not be limited to the configuration in FIG. 1; the system can be modified in various manners such that, for instance, the configuration may be omitted partly, or another configuration may be added. For example, although FIG. 1 illustrates the terminal device 200 composed of two terminal devices, which are a terminal device 200-1 and a terminal device 200-2, the terminal device 200 may be composed of any number of terminal devices. Further, the same applies to FIGS. 2 and 3, which will be described later on, where modifications, such as omission and addition of constituent elements, can be made.

The information processing system 10 in this embodiment corresponds to, for instance, the server system 100. It is noted that the technique in this embodiment is not limited to the foregoing; the information processing system 10 may execute a process, which will be described in the Specification, through distributed processing by the use of the server system 100 and another device. For instance, the information processing system 10 in this embodiment may be implemented through distributed processing by the use of the server system 100 and terminal device 200. The Specification will describe an instance where the information processing system 10 is a server system 100.

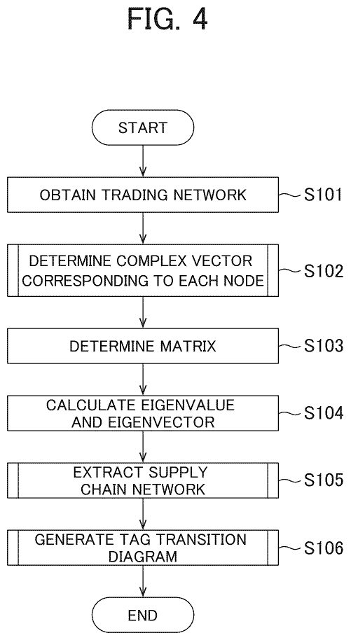

The server system 100 may be a single server or may include a plurality of servers. For instance, the server system 100 may include a database server and an application server. The database server stores various kinds of data, including a trading network 121 and a complex vector, both of which will be described later on. The application server executes processing that will be described later on with reference to, but not limited to, FIGS. 4, 7, 8, 11A, 11B, 15, and 16. It is noted that the plurality of servers herein may be physical servers or may be virtual servers. It is also noted that when virtual servers are used, they may be provided in a single physical server or may be distributed to a plurality of physical servers. As described above, the specific configuration of the server system 100 in this embodiment can be modified in various manners.

The terminal device 200 is a device that is used by a user of the information processing system 10. The terminal device 200 may be a personal computer (PC), a mobile terminal device, such as a smartphone, or any other like device having a function that will be described in the Specification.

The server system 100 communicates with a terminal device 200-1 and a terminal device 200-2 over, for instance, a network. Hereinafter, a plurality of terminal devices will be simply referred to as a terminal device 200 unless these terminal devices have to be distinguished from each other. The network, although being herein a public communication network, such as the Internet, may be a local area network (LAN) or other things.

The information processing system 10 in this embodiment is an open-source intelligence (OSINT) system for, but not limited to, collecting and analyzing data related to a target by the use of, for instance, open information. The open information herein includes various kinds of information widely accessible and legally available. Examples of the open information may include securities reports, inter-industry relations tables, official announcements of a government, news reports on countries and companies, and supply chain databases. Further, the open information may include various kinds of information that are transmitted and received via a social networking service (SNS). For instance, the SNS may include services that allow texts, images or other things to be posted, and the open information in this embodiment may include these texts or images or include their results obtained through natural language processing, image processing or other processing.

The server system 100 generates nodes including various attributes in accordance with open information. A single node represents a given entity. The entity herein is a company. Attributes (tags) provided to a node are various kinds of information, such as the company's name, nationality, business field, industrial classification, trading partners, and trading goods, that are determined based on open information. When a node representing an entity is a company, the node is provided with attributes related to this company. It is noted that the attributes herein may include, but not limited to, sales, the number of employees, shareholders and their capital contribution ratios, and board members. In this embodiment, among the attributes, at least an industrial classification is provided to the node. The industrial classification is a kind of an industry classified by a characteristic of the industry. Industrial classification codes, for instance, may be used as an industrial classification. The industrial classification codes are information with a code, such as “01”, assigned to individual industries classified into several fields. The industrial classification codes, although being the North American Industry Classification System (NAICS) for instance, may be another classification code, such as the International Standard Industrial Classification or the Japan Standard Industrial Classification.

When there is a relationship between a given node and another node, the given node and the other node are connected together by an edge having a direction. For instance, let a given company provide (sell) a trading product of some kind to another company. In this case, a node corresponding to the other company, and a node corresponding to the given company are connected together by an edge provided with an attribute representing the product's buy-sell relationship (distribution relationship). The edge herein is an edge having a direction from an influencing entity to an influenced entity, that is, for instance, from a seller to a buyer of a product of some kind. That is, the edge indicates a trading relationship in which a supply source company of a product is associated with a supply destination company of the product. The attribute given to the edge is not limited to the product; various kinds of information, including, a start company, an end company, and a product as well as its price and the amount (number) of trading products, can be included. It is noted that the information about the product is not an essential attribute that is to be given to the edge and can be thus omitted. The same holds true for the other information pieces, such as a start company; these information pieces may be given to the edge as attributes or may be omitted.

In the technique in this embodiment, the server system 100 obtains an entity network, which is a network in which a plurality of nodes representing a plurality of entities (e.g., companies) are connected together by a plurality of edges indicating trading relationships. Since the edges have directions, the entity network is a directed graph. The server system 100 conducts an analysis based on the entity network and executes processing to present the results of the analysis. For instance, the terminal device 200 is a device that is used by a user of a service provided by the OSINT system. For instance, the user uses the terminal device 200 to send a request to the server system 100, which is the information processing system 10, to conduct an analysis of some sort. The server system 100 conducts an analysis based on the entity network and transmits the results of the analysis to the terminal device 200.

The entity network is herein a network representing a company-to-company trading relationship. It is noted that there are two types of paths in the entity network: (A) a chain (upstream) pertaining to the trading of various items actually related to the company's product as components and materials and/or a chain (downstream) pertaining to the trading of the company's product; and (B) a chain in which multiple trading matters not directly pertaining to the company are linked by chance. As such, this embodiment will describe an entity network representing a trading relationship obtained based on open information as a trading network, and a part of the entity network pertaining to substantial trading on a given company as a supply chain network. That is, the trading network is a network including both (A) and (B), and the supply chain network pertaining to the given company is a network presumably including (A) without (B).

FIG. 2 is a functional block diagram illustrating an example of the detailed configuration of the server system 100. The server system 100 includes, as illustrated in FIG. 2 for instance, a processing unit 110, a storage unit 120, and a communication unit 130.

The processing unit 110 in this embodiment is composed of hardware below. The hardware can include at least one of a digital-signal processing circuit and an analog-signal processing circuit. For instance, the hardware can be composed of one or more circuit devices mounted on a circuit board, or one or more circuit elements mounted on the same. Example of one or more circuit devices include integrated circuits (ICs) and field-programmable gate arrays (FPGAs). Examples of one or more circuit elements include resistors and capacitors.

Further, the processing unit 110 may be implemented in the form of a processor below. The server system 100 in this embodiment includes a memory that stores information, and a processor that operates on the basis of the information stored in the memory. Examples of the information include a program and various kinds of data. The program may include a program to cause the server system 100 to execute processing that will be described in the Specification. The processor includes hardware. The processor can be various kinds of processors, including a central processing unit (CPU), a graphics processing unit (GPU), and a digital signal processor (DSP). The memory may be a semiconductor memory, such as a static random access memory (SRAM), a dynamic random access memory (DRAM), or a flash memory; alternatively, the memory may be a resistor; alternatively, the memory may be a magnetic storage device, such as a hard disk drive (HDD); alternatively, the memory may be an optical storage device, such as an optical disc drive. For instance, the memory holds a computer-readable instruction, and the processor executes this instruction, thus implementing the function of the processing unit 110 as a process. The instruction herein may be a set of instructions constituting the program, or an instruction for instructing a hardware circuit of the processor to operate.

The processing unit 110 includes, for instance, a trading network obtaining unit 111, a vector obtaining unit 112, a matrix obtaining unit 113, a supply chain extracting unit 114, a tag-transition-diagram generating unit 115, and a subnetwork extracting unit 116.

The trading network obtaining unit 111 obtains the trading network 121. For instance, the trading network obtaining unit 111 may obtain the trading network obtaining unit 121 in accordance with open information. The open information includes trading relationship information in which a supply source company of a product is associated with a supply destination company of the product. The trading network obtaining unit 111 stores the generated trading network 121 in the storage unit 120. It is noted that the trading network 121 may be generated by a system that is different from the information processing system 10 according to this embodiment. The trading network obtaining unit 111 in this case may execute processing to obtain the generated result from this different system.

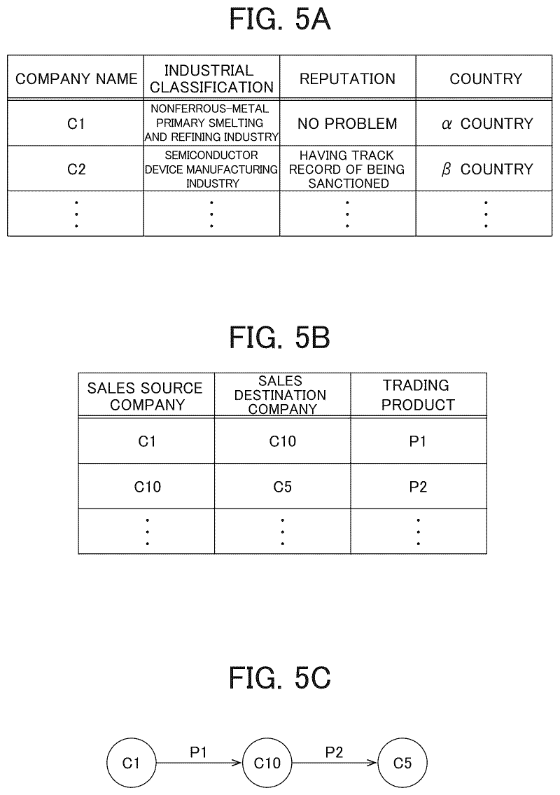

As will be described later on with reference to FIGS. 5A to 5C for instance, the trading network obtaining unit 111 may obtain a network in which a plurality of nodes corresponding to a plurality of companies are connected together, as the trading network 121 in accordance with the trading relationships between the companies.

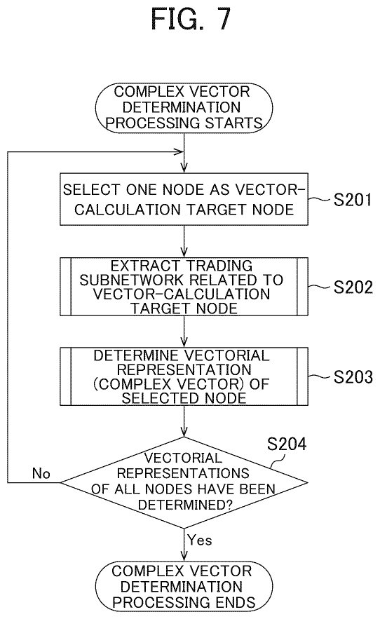

The vector obtaining unit 112 obtains the vectorial representation (complex vector) of each of the nodes included in the trading network 121. Specifically, the vector obtaining unit 112 selects any one of the plurality of nodes as a vector-calculation target node, and the vector obtaining unit 112 determines, for each of the plurality of nodes, a complex vector indicating the relationship of this vector-calculation target node with another one of the plurality of nodes, by assigning a complex number having a phase corresponding to the distance to the vector-calculation target node, and having an absolute value corresponding to the amount of flow going to or coming from the vector-calculation target node. How to determine the vector representation will be described later on with reference to FIGS. 7 to 14 and others. The vector obtaining unit 112 stores the obtained complex vector of each of the plurality of nodes in the storage unit 120.

The matrix obtaining unit 113 determines a complex correlation matrix C in accordance with the complex vector of each of the plurality of nodes obtained by the vector obtaining unit 112. The matrix obtaining unit 113 also determines an eigenvalue and an eigenvector by subjecting the complex correlation matrix C to eigenvalue decomposition.

The supply chain extracting unit 114 extracts the supply chain network 122, which is a part of the trading network 121, in accordance with the complex vector, which indicates each of the plurality of nodes. Specifically, the supply chain extracting unit 114 may extract the supply chain network 122 representing the substantial trading relationship of a given company, from the trading network 121 in accordance with the eigenvector. For instance, the supply chain extracting unit 114 executes the following: first processing to extract, as a supply-chain-network group, a set of networks that constitute the supply chain network 122 for at least one company without limiting companies; and second processing to further extract a part of the supply-chain-network group determined by attributes, including a target company and a target product.

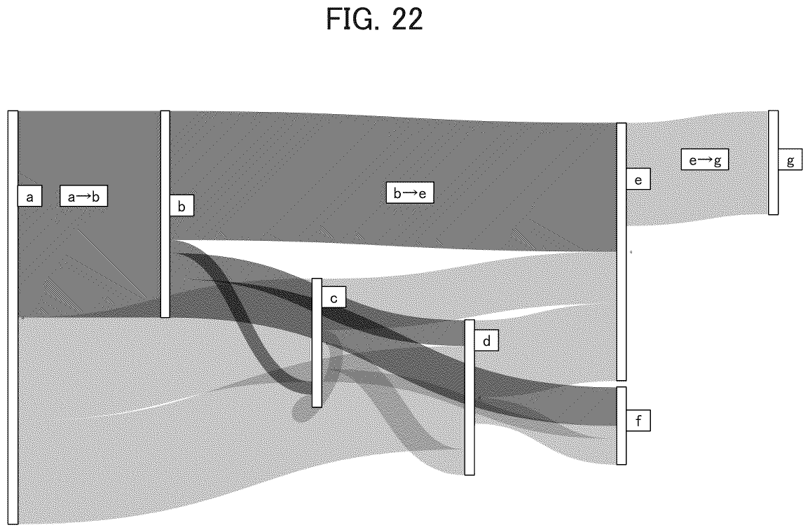

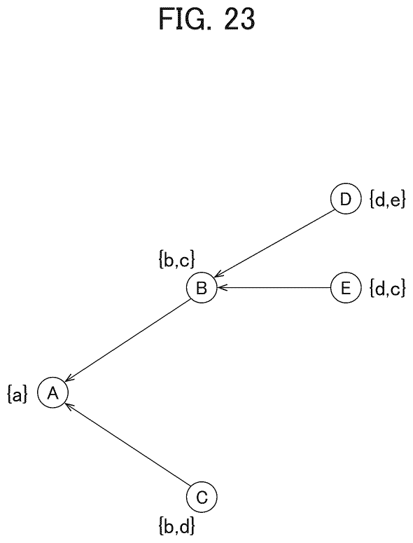

Based on a tag provided to a node selected from among the plurality of nodes in the trading network and included in the supply chain network 122, the tag-transition-diagram generating unit 115 generates a tag transition diagram showing information about the tag in the supply chain network 122. The tag herein is additional information provided to the node; the tag may be a combination of the above-described various attributes and the attribute values of the attributes. Further, this tag information shown by the tag transition diagram may be specifically information indicating the relationship between a plurality of tags included in the supply chain network 122. The tag transition diagram is a Sankey diagram for example, which will be described later on with reference to FIG. 22, but other diagrams may be used. The tag transition diagram is displayed on a display unit 240 of the terminal device 200 for example.

The subnetwork extracting unit 116 extracts a subnetwork composed of a part of the supply chain network 122. For example, the subnetwork extracting unit 116 may obtain one or more selections from among a plurality of tag transition patterns shown in the tag transition diagram. For instance, the selections are made by the user of the terminal device 200. The subnetwork extracting unit 116 extracts, as a subnetwork, a part of the supply chain network 122 composed of the selected transition pattern. The subnetwork is displayed on the terminal device 200 for instance.

The storage unit 120 is the working region of the processing unit 110 and stores various kinds of information. The storage unit 120 can be implemented in the form of various kinds of memory; the memory may be a semiconductor memory, such as an SRAM, a DRAM, a ROM, and a flash memory; alternatively, the memory may be a resistor; alternatively, the memory may be a magnetic storage device, such as a hard disk drive; alternatively, the memory may be an optical storage device, such as an optical disc drive.

The storage unit 120 stores the supply chain network 121 obtained by the trading network obtaining unit 111 for instance. The storage unit 120 also stores the supply chain network 122 extracted by the supply chain extracting unit 114. Further, the storage unit 120 may store open information, such as securities reports and inter-industry relations tables. For instance, the storage unit 120 also stores, but not limited to, industrial classification codes 123 and a regulated-companies list 124. The industrial classification codes 123 are information with a code, such as “01”, assigned to each of industries classified into several fields. The regulated-companies list 124 is information for identifying a company having a problem in view of, for example, the ESG. Other than the foregoing, the storage unit 120 can store various kinds of information pertaining to the processing that is executed in this embodiment.

The communication unit 130 is an interface for communication over a network and includes, for instance, an antenna, a radio frequency (RF) circuit, and a baseband circuit. The communication unit 130 may operate under the control of the processing unit 110 or may include a communication controlling processor that is different from the processing unit 110. The communication unit 130 is an interface for performing communication in accordance with, for instance, the transmission control protocol/Internet protocol (TCP/IP). It is noted that the specific communication scheme can be modified in various manners.

FIG. 3 is a block diagram illustrating an example of the detailed configuration of the terminal device 200. The terminal device 200 includes a processing unit 210, a storage unit 220, a communication unit 230, the display unit 240, and an operation unit 250.

The processing unit 210 is composed of hardware including at least one of a digital-signal processing circuit and an analog-signal processing circuit. Further, the processing unit 210 may be implemented in the form of a processor. The processor can be various processors, such as a CPU, a GPU, and a DSP. The processor executes an instruction stored in the memory of the terminal device 200, so that the function of the processing unit 210 is implemented in the form of processing.

The storage unit 220 is the working region of the processing unit 210 and is implemented in the form of various memories, such as an SRAM, a DRAM, and a ROM.

The communication unit 230 is an interface for communication over a network and includes, for instance, an antenna, an RF circuit, and a baseband circuit. The communication unit 230 communicates with the server system 100 over, for instance, a network.

The display unit 240 is an interface that displays various kinds of information. The display unit 240 may be a liquid crystal display, an organic EL display, or a display that operates under any other scheme. The operation unit 250 is an interface that receives an input operated by the user. The operation unit 250 may be, but not limited to, buttons provided in the terminal device 200. Further, the display unit 240 and the operation unit 250 may be combined together to constitute a touch panel.

In the technique in this embodiment, a complex vector reflecting a phase (distance) is used as the vectorial representation of each node, and by the use of the complex vector, the supply chain network 122 is extracted from the trading network 121. As such, even if the trading network 121 is a network composed of many nodes and edges including both (A) and (B) described above, it is possible to extract highly important information therefrom as the supply chain network 122, and to generate a tag transition diagram showing the supply chain network 122. As a result, the overview of the supply chain network 122 representing the essential trading relationship for a given company can be presented in an easy-to-understand manner, thereby enabling appropriate support to user judgement and analysis.

Further, the processing that is performed by the information processing system 10 in this embodiment may be, in part or in whole, implemented in the form of a program. The processing that is performed by the information processing system 10 is, in a narrow sense, processing that is performed by the processing unit 110 of the server system 100, but may include processing that is performed by the processing unit 210 of the terminal device 200.

The program according to this embodiment can be stored in a non-transitory information storing medium (information storing device), an example of which is a computer-readable medium. The information storing medium can be implemented in the form of, but not limited to, an optical disk, a memory card, an HDD, or a semiconductor memory. The semiconductor memory is a ROM for instance. The processing unit 110 and others perform various processes in this embodiment based on programs stored in the information storing medium. That is, the information storing medium stores a program for causing a computer to function as the processing unit 110 and others. The computer is a device provided with an input device, a processing unit, a storage unit, and an output unit. Specifically, the program according to this embodiment is a program for causing a computer to execute individual process steps that will be described later on with reference to FIG. 4 and others.

The technique in this embodiment is applicable to a method of information processing including process steps described below. The method of information processing includes the following process steps that are performed by the information processing system 10: obtaining the trading network 121 in which a plurality of nodes corresponding one-to-one to a plurality of companies are connected together by an edge indicating a trading relationship; selecting any one of the plurality of nodes as a vector-calculation target node, and determining, for each of the plurality of nodes, a complex vector by assigning a complex number, the complex vector indicating a relationship of the vector-calculation target node with another one of the plurality of nodes, the complex number having a phase corresponding to a distance to the vector-calculation target node, and an absolute value corresponding to an amount of flow going to or coming from the vector-calculation target node; extracting the supply chain network 122 that is a part of the trading network 121, in accordance with the complex vector indicating each of the plurality of nodes; and generating a tag transition diagram in accordance with a tag given to nodes included in the supply chain network 122 of the plurality of nodes, the tag transition diagram showing information about the tag in the supply chain network 122.

### 2. Flow of Processing

### 2.1 Overall Flow

FIG. 4 is a flowchart schematically illustrating processing that is executed in the information processing system 10 in this embodiment.

In Step S101, the trading network obtaining unit 111 firstly obtains the trading network 121. The trading network obtaining unit 111 stores the trading network 121 in the storage unit 120.

In Step S102, the vector obtaining unit 112 determines the vectorial representation of each of a plurality of nodes included in the trading network 121. The vector obtaining unit 112 stores the determined vectorial representation in the storage unit 120.

In Step S103, the matrix obtaining unit 113 determines the complex correlation matrix C in accordance with the vectorial representation. In Step S104, the matrix obtaining unit 113 subjects the complex correlation matrix C to eigenvalue decomposition, to thus determine an eigenvalue and an eigenvector. The matrix obtaining unit 113 stores at least the eigenvector in the storage unit 120.

In Step S105, the supply chain extracting unit 114 extracts the supply chain network 122 from the trading network 121 in accordance with the eigenvector. For instance, the supply chain extracting unit 114 may extract the supply chain network 122 related to a given product Y of a given company X.

In Step S106, the tag-transition-diagram generating unit 115 generates a tag transition diagram showing the relationship of a tag (attribute), in accordance with the supply chain network 122 obtained in Step S105. Although not illustrated in FIG. 4, the processing unit 110 may include a display control unit; this display control unit may control the display unit 240 of the terminal device 200 to display the tag transition diagram.

The following details processing in each step.

### 2.2 Obtainment of Trading Network

Processing to obtain the trading network 121, which corresponds to Step S101 in FIG. 4, will be described. The trading network obtaining unit 111 may generate the trading network 121 in accordance with open information. The open information includes information, such as securities reports and press releases.

The trading network obtaining unit 111 identifies, for each of many companies, various kinds of information, such as the name, nationality, business field, business partners and trading goods of the company. The trading network obtaining unit 111 may also identify, but not limited to, the number of employees, shareholders as well as their capital contribution ratio, and board members of each company in accordance with the open information.

The trading network obtaining unit 111 may also obtain reputation information indicating a reputation of each company in accordance with the open information. For instance, the reputation information is information indicating, but not limited to, whether a target company has a problem or a history of being sanctioned in view of environment, social, and governance (ESG). For instance, the reputation information may be information indicating, but not limited to, that a target company is a company violated export regulations, a company handling conflict minerals, a company involved in slave labor, or a company involved in illegal logging. Further, the open information may be a document issued by, for instance, a government institute, and the reputation information may be information indicating whether a target company is subjected to restriction on trading with a predetermined country or other things. Further, as earlier described, the open information may include information about the SNS; the reputation information herein may be information determined based on the SNS. For instance, the trading network obtaining unit 111 may obtain the reputation information in accordance with SNS information sent from the official account of, for instance, a company. Further, the SNS information that is used in the technique in this embodiment shall not be limited to information sent from an official account. For instance, on the SNS, when a predetermined number or more of users have sent out the name of a given company along with a word, such as “conflict minerals”, “slave labor”, or “illegal logging”, the given company may be associated with negative reputation information.

FIGS. 5A and 5B illustrate examples of the structure of data that is obtained based on open information. As illustrated in FIG. 5A, the trading network obtaining unit 111 obtains information in which each company included in the open information is associated with a company name, an industrial classification, a reputation, and a nationality.

The company name is, for instance, text data indicating the name of a target company. The industrial classification is information indicating the business field of the target company. The reputation is, as described above, information indicating whether the target company has a problem in view of the ESG. The nationality is information indicating a country to which the target company belongs.

It is noted that although the industrial classification is shown in the form of a text in FIG. 5A, information indicating the industrial classification may be denoted by an industrial classification code. For the Japan Standard Industrial Classification for instance, a code “231” is assigned to the primary smelting and refining of non-ferrous metals, and a code “2813” is assigned to the semiconductor devices. It is noted that the industrial classification may be another classification, such as NAICS, as earlier described. For convenience in description, the industrial classification will be hereinafter a text indicating a classification name. It is noted that a classification name in the following processing can be substituted for an industrial classification code. Further, the storage unit 120 may contain the industrial classification code 123, as illustrated in FIG. 2. The industrial classification code 123 is information in which, for instance, a classification name and a classification code in NAICS are associated with each other. The processing unit 110 may execute conversion processing between the classification name and classification code in accordance with the industrial classification code 123.

Further, as illustrated in FIG. 5B, the trading network obtaining unit 111 obtains information indicating company-to-company trading in accordance with the open information. For instance, the trading relationship information included in the open information is the information illustrated in FIG. 5B, or information capable of identifying the information illustrated in FIG. 5B. The information indicating the company-to-company trading is information in which, for instance, information for identifying a sales source company, information for identifying a sales destination company, and information for identifying a product to be traded are associated with one another.

Based on these information items, the trading network obtaining unit 111 generates the trading network 121 in the form of a directed graph in which companies are represented by nodes, and in which their trading relationships are represented by edges.

FIG. 5C illustrates part of the trading network 121 generated based the trading relationship shown in FIG. 5B. FIG. 5B shows a relationship in which a company C1 sells a product P1 to a company C10. The trading network obtaining unit 111 in this case provides an edge directed from C1 to C10, between a node representing the company C1 and a node representing the company C10. As illustrated in FIG. 5A, the node representing the company C1 is associated with the company name “C1”, and further with information on items, such as an industrial classification, a reputation, and a nationality. The same applies to the node representing the company C10. Further, the edge directed from C1 to C10 is associated with P1, which denotes a traded product. It is noted that the trading network obtaining unit 111 may obtain information, such as a trading volume and a trading price, in accordance with open information, and that these information items may be associated with an edge.

FIG. 5B also shows a relationship in which the company C10 sells a product P2 to a company C5. The trading network obtaining unit 111 in this case provides an edge directed from C10 to C5, between the node representing the company C10 and a node representing the company C5. Each of the nodes is associated with the information illustrated in FIG. 5A, and each of the edges is associated with information on a traded product and other things.

It is noted that as earlier described, a provider (seller) of a product of some sort is referred to as “upstream” in the trading network 121, which is a directed graph, and a receiver (buyer) of a product of some sort is referred to as “downstream” in the same. It is noted that the same definition of upstream and downstream is also applied to the supply chain network 122, which will be described later on.

The trading network 121 herein is, in a narrow sense, a network including nodes corresponding to all companies included in open information that is to be processed. Thus, the trading network 121 may be a network including so many nodes, and the number of nodes may be approximately several thousand or more. It is noted that the configuration of the trading network 121 may be modified in various manners; an example is deleting some of the companies included in the open information.

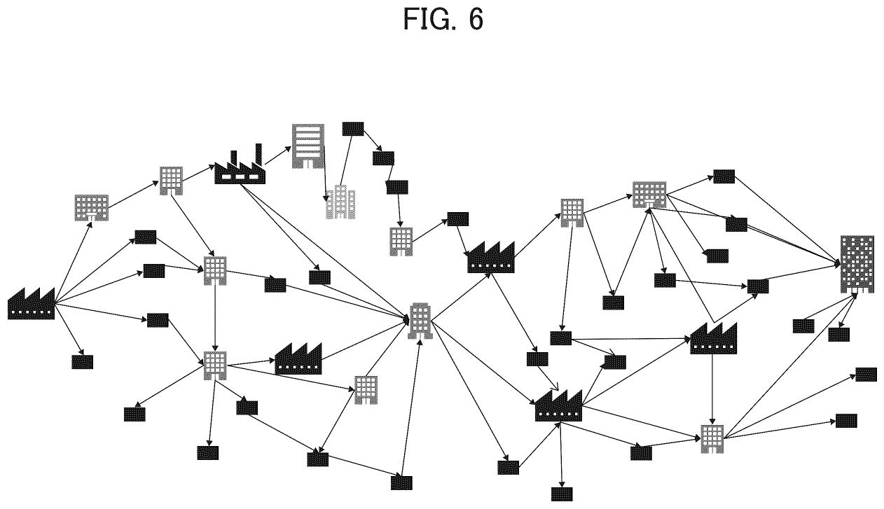

FIG. 6 is a schematic diagram illustrating the trading network 121. As illustrated in FIG. 6, the trading network 121 is a directed graph in which a plurality of nodes are connected together through edges representing trading relationships. It is noted that for easy illustration, the nodes in FIG. 6 are depicted in different shapes, depending on whether the nodes represent manufacturing plants, distribution hubs, or other things. As earlier described, the information obtained includes, but not limited to, the names, industrial classifications of companies corresponding to the respective nodes; hence, the display mode of the trading network 121 can be changed depending on, for instance, the industrial classifications. It is noted that the technique in this embodiment does not necessarily require such node shape control.

It is noted that FIGS. 5A and 5B illustrate examples of the data structure related to the trading network 121; a specific data structure shall not be limited to these examples. For instance, although FIGS. 5A and 5B illustrate an instance where table data, such as a relational database, is used, data of another structure may be used. Further, even in the use of table data, the number of tables shall not be limited to two; the tables may be managed in the form of either one combined table, or three or more divided tables. Furthermore, some of the items illustrated in FIGS. 5A and 5B may be omitted, or another item may be added. For instance, the trading network obtaining unit 111 may obtain information indicating company names, industrial classification codes, and buy-sell directions and may omit other information.

### 2.3 Calculation of Vectorial Representation 2.3.1 Extraction of Trading Network Related to Vector-Calculation Target Node

FIG. 7 is a flowchart showing the process for determining a complex vector, which corresponds to in Step S102 in FIG. 4. Upon the start of this process, the vector obtaining unit 112 firstly selects one of a plurality of nodes included in the trading network 121 as a vector-calculation target node.

In Step S202, the vector obtaining unit 112 extracts a trading subnetwork related to the vector-calculation target node. The trading subnetwork is a network included in the trading network 121 and including the vector-calculation target node.

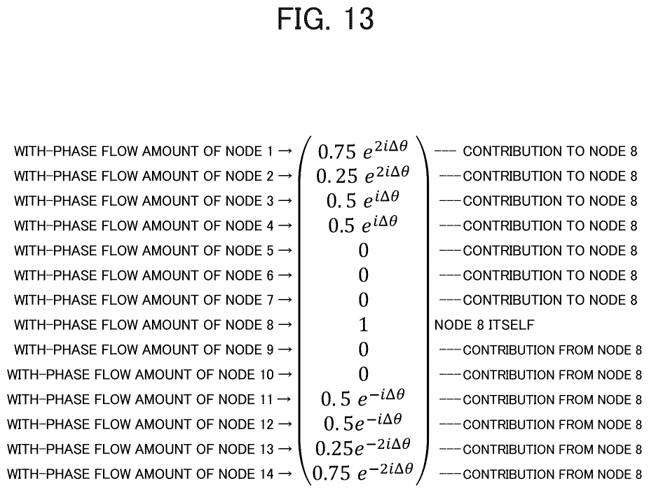

In Step S203, the vector obtaining unit 112 determines the vectorial representation of the vector-calculation target node in accordance with the trading subnetwork extracted in Step S202. The vector herein is, as will be described later on with reference to FIG. 13, a complex vector composed of elements each of which is a complex number having a size and a phase.

In Step S204, the vector obtaining unit 112 determines whether the vectorial representations of all the nodes included in the trading network 121 have been determined. If there is a node whose vectorial representation has not yet been calculated (if NO in Step S204), the process goes back to Step S201 and continues. For instance, the vector obtaining unit 112 selects a node whose complex vector has not yet been calculated, as a vector-calculation target node and determines the vectorial representation of this vector-calculation target node.

If the vectorial representations of all the nodes have been calculated (if YES in Step S204), the vector obtaining unit 112 ends the process shown in FIG. 7.

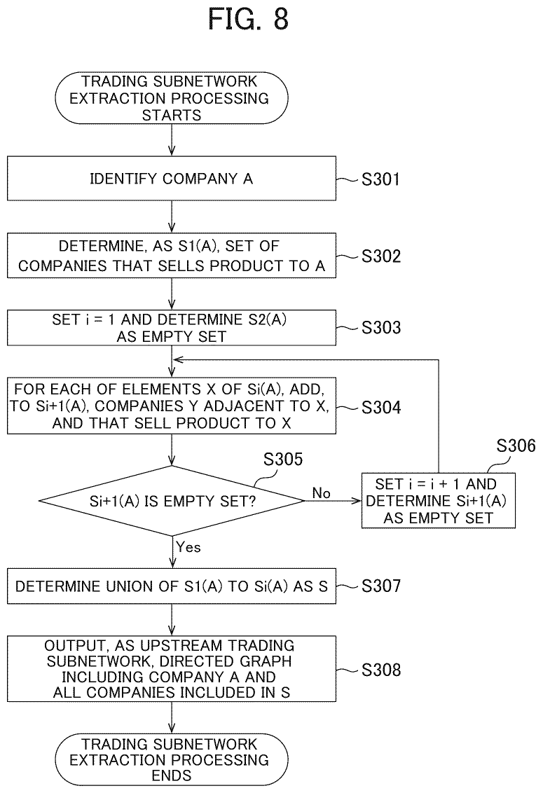

FIG. 8 is a flowchart showing the process for extracting a trading subnetwork, which corresponds to Step S202 in FIG. 7.

In Step S301, the vector obtaining unit 112 determines a specific company that is to be a basis for the extraction of a trading subnetwork. The specific company herein may be, for instance, a company corresponding to the vector-calculation target node selected in Step S202 in FIG. 7. For instance, a plurality of nodes included in the trading network 121 are selected sequentially as vector-calculation target nodes, as shown in Steps S201 through S204 in FIG. 7. The specific company will be hereinafter referred to as a company A.

In Step S302, the vector obtaining unit 112 selects all companies X adjacent to the company A, corresponding to the vector-calculation target node, and that sells something to the company A, and the vector obtaining unit 112 determines a set of the selected companies X as S1(A).

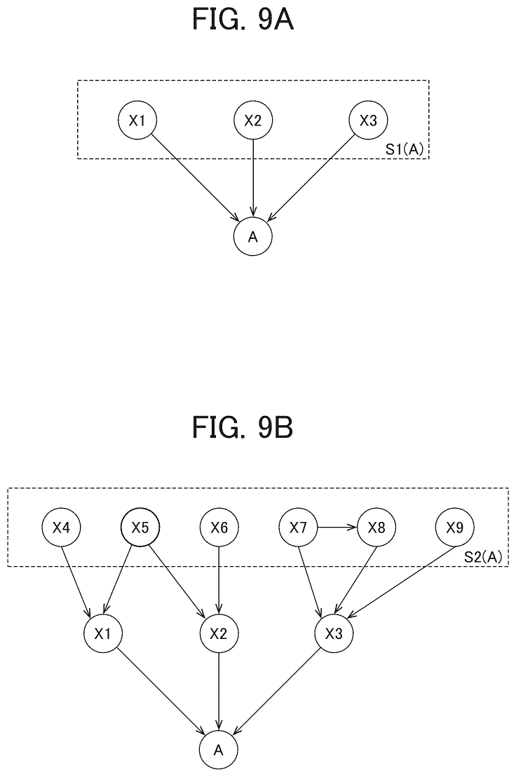

FIG. 9A illustrates S1(A) by way of example. For instance, FIG. 9A illustrates the trading network 121 with a part including the company A extracted. In the example in FIG. 9A, a node representing a company X1 is directly connected to a node representing the company A through an edge directed from X1 to A. That is, X1, which is a company adjacent to the company A, and that sells something to the company A, is determined as an element of S1(A). Likewise, X2 and X3, which are also companies adjacent to the company A and selling something to the company A, are determined as elements of S1(A). S1(A) in this case is a set of three elements: X1, X2, and X3.

In Step S303, the vector obtaining unit 112 initializes a search variable i to 1 and determines Si+1 (A) as an empty set. Here, i is initialized to 1, and Si+1 (A) is thus S2(A). Accordingly, the vector obtaining unit 112 herein determines S2(A) as an empty set.

In Step S304, for each of the elements X of Si(A), the vector obtaining unit 112 adds, to Si+1 (A), all companies Y adjacent to the element X, and that sells a product to the element X. When the processing in Step S304 is executed on a given company A for the first time, i=1 is established. Accordingly, in this case, for each of the elements X of S1(A), the vector obtaining unit 112 adds, to S2(A), all the companies Y adjacent to X, and that sells a product to X.

FIG. 9B illustrates S2(A) by way of example. S1(A) in this example is a set of three elements: X1, X2, and X3, as earlier described with reference to FIG. 9A. The vector obtaining unit 112 firstly identifies a company Y adjacent to X1, and that sells a product to X1. Here, two elements, i.e., X4 and X5 satisfy this condition, and thus, these two companies are added to S2(A). The vector obtaining unit 112 next identifies a company Y adjacent to X2, and that sells a product to X2. Here, two elements, i.e., X5 and X6 satisfy this condition. Since X5 has already been added to S2(A), X6 is added to S2(A). The vector obtaining unit 112 next identifies a company Y adjacent to X3, and that sells a product to X3. Here, three elements, i.e., X7, X8, and X9 satisfy this condition, and thus, these three companies are added to S2(A). As a result, a set of six elements, i.e., X4, X5, X6, X7, X8, and X9 is generated as S2(A) in Step S304, as illustrated in FIG. 9B for instance.

In Step S305, the vector obtaining unit 112 determines whether Si+1 (A) is an empty set. In the example in FIG. 9B, S2(A), which contains six elements, is determined as not being an empty set (NO in Step S305). In this case, the vector obtaining unit 112 in Step S306 increments the variable i to initialize Si+1 (A) to an empty set. The process then goes back to Step S304. For instance, the vector obtaining unit 112 determines S2(A), as illustrated in FIG. 9B, and then initializes S3(A) to an empty set in Step S306, followed by going back to the processing in Step S304.

In this case, the vector obtaining unit 112 in Step S304 identifies a company Y adjacent to each of the elements X in S2(A), and that sells a product to X, and the vector obtaining unit 112 adds the company Y to S3(A). For instance, the vector obtaining unit 112 identifies a company adjacent to X4, and that sells a product to X4, and the vector obtaining unit 112 adds the identified company to S3(A). The same applies to X5 to X9; the vector obtaining unit 112 adds, to S3(A), a company adjacent to each company, and that sells a product to this company.

If S3(A) is not an empty set, the determination result in Step S305 is NO, and thus, the process goes back to Step S304 again and executes processing to determine S4(A). The succeeding processing is executed in a similar manner; until Si+1 (A) becomes an empty set, the processing from Steps S304 through S306 is repeated.

That Si+1 (A) is an empty set in Step S305 means that there is no element found that satisfies the condition as the result of the processing in Step S304. That is, none of the companies X, which are the elements of Si(A), has any more upstream company.

Thus, in this case (if YES in Step S305), the vector obtaining unit 112 in Step S307 determines a union of S1(A), S2(A), . . . , and Si(A) as S.

In Step S308, the vector obtaining unit 112 outputs, as a trading subnetwork, a directed graph including a node corresponding to the company A, and nodes corresponding to all companies included in S. The trading subnetwork, which is herein a subnetwork representing upstream companies with reference to the company A, corresponding to a vector-calculation target node, is also referred to as an upstream trading subnetwork.

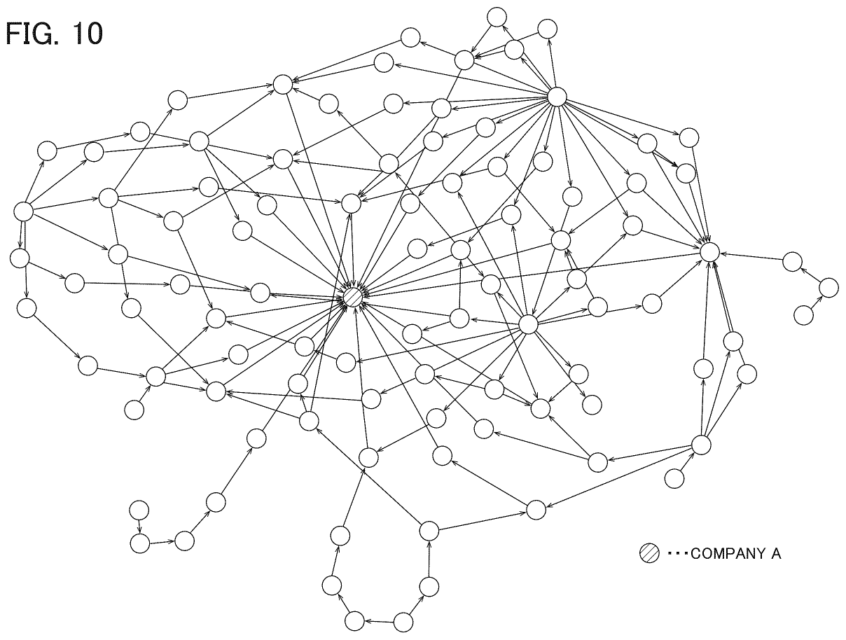

FIG. 10 illustrates an example of an upstream trading subnetwork. As illustrated in FIG. 10, the upstream trading subnetwork is a directed graph composed of nodes representing companies directly or indirectly connected to the company A. Doing so enables a portion related to a desired company to be extracted appropriately from the trading network 121. The upstream trading subnetwork, which is information that enables identification of a relationship of connection between a company and the company A, is useful information for representing a feature of the company A by the use of a complex vector.

It is noted that in determining Si+1 (A) in Step S304, the vector obtaining unit 112 may identify the company Y in accordance with a condition, “the company Y is not included in a union of {A}, S1(A), . . . , and Si(A)” in addition to the condition, “the company Y is adjacent to and sells something to the element X of Si(A)”.

For instance, reference is made to a case in which three companies Xa, Xb, and Xc exhibit a cycle of Xa←Xb←Xc←Xa, where Xa is an element of Si−2(A), where Xb is an element of Si−1(A), where Xc is an element of Si(A). Here, “Xa←Xb” indicates that Xb is adjacent to and sells something to Xa. In this case, even though Xa is already an element of Si−2(A), Xa can be an element of Si+1 (A) because it is adjacent to and sells something to Xc. That is, when the cycle is reflected as well, the processing that is executed by the vector obtaining unit 112 can become complicated. On that point, when the above condition “the company Y is not included in a union of {A}, S1(A), . . . , and Si(A)” is added, Xa is excluded from the elements of Si+1 (A), thus enabling the processing to be simplified.

Further, in Step S305 in FIG. 8, the vector obtaining unit 112 may determine whether i≥k is established, in addition to whether Si+1 (A) is an empty set. Herein, k is a value for determining the number of stages that are targets for extracting a trading subnetwork. Although k is a value of, for instance, about three, a different value may be set. In response to satisfaction of at least one of a first condition where Si+1 (A) is an empty set, and a second condition where i≥k is established, the vector obtaining unit 112 may determine NO in Step S305 and may then end a further search. Doing so can limit the number of upstream stages in a trading subnetwork for determining a vectorial representation to k stages. Consequently, a company that is distant from a company corresponding to a vector-calculation target node can be excluded from the processing, thereby enabling load reduction in the processing. To be more specific, the number of elements whose values stand at 0 in their vectorial representations, which will be described later on, can be increased, thereby enabling calculation-load reduction in processing by the use of a complex vector (e.g., similarity calculation, and eigenvalue decomposition of the complex correlation matrix C).

It is noted that the foregoing has described an upstream trading subnetwork composed of upstream companies with reference to the company A. Nevertheless, a trading subnetwork shall not be limited to an upstream trading subnetwork; the trading subnetwork may include a downstream trading subnetwork. For the downstream trading subnetwork, the processing, which is similar to that in FIG. 8 with the exception that the search direction is changed, will not be described. For instance, the vector obtaining unit 112 extracts the trading subnetwork of a vector-calculation target node in a range including k stages upstream of the vector-calculation target node and k stages downstream of the same.

### 2.3.2 Processing to Determine Vectorial Representation

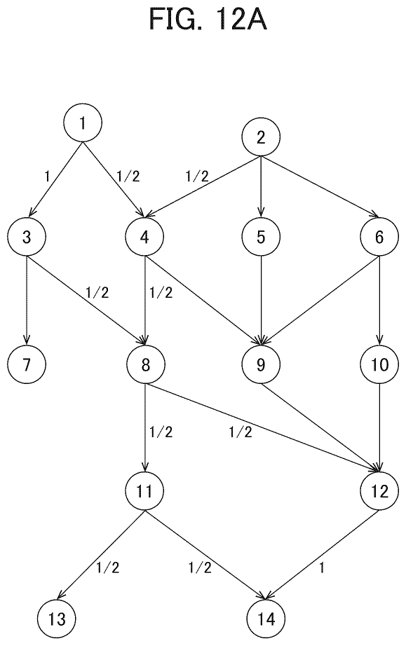

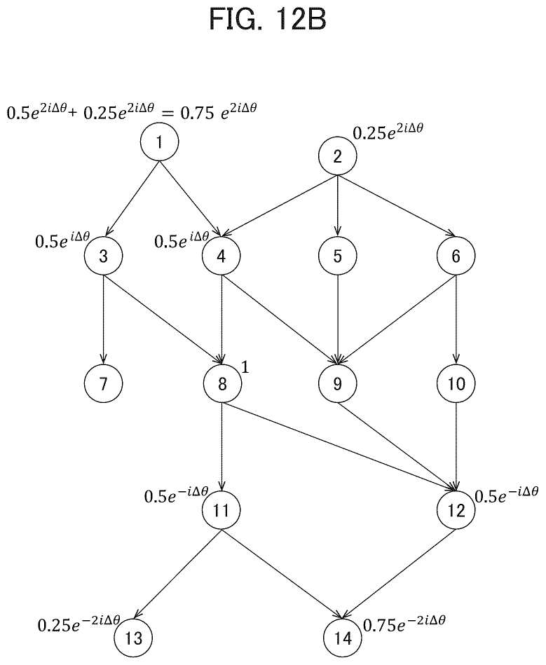

Processing to determine the vectorial representation of a vector-calculation target node in accordance with a trading subnetwork will be next described. In the technique in this embodiment, the vector obtaining unit 112 determines, for each of the nodes included in the trading subnetwork of the vector-calculation target node, a complex vector representing the vector-calculation target node, by assigning a complex number having a phase corresponding to the distance to the vector-calculation target node, and having an absolute value corresponding to the amount of flow going to or coming from the vector-calculation target node. It is noted that the amount of flow in this embodiment is the amount of something that flows through a directed graph. The graph in this embodiment is a directed graph directed from upstream companies to downstream companies, and the amount of flow in this embodiment indicates the level of influence of the upstream companies that is exerted on the downstream companies. As will be described later on with reference to FIG. 12A, the amount of flow in this embodiment may be information determined based on a relationship of connection between nodes in a directed graph. Alternatively, the amount of flow may be information reflecting, for instance, a specific quantity of a product (including materials, raw materials, a manufacturing apparatus, and other things) that is supplied from an upstream company to a downstream company.

The technique in this embodiment enables the amount of flow in a directed graph, which is herein the trading network 121 (in a narrow sense, a trading subnetwork), to be represented by the use of an absolute value and also enables the distance between nodes to be represented by the use of a phase. This enables a vectorial representation reflecting accurately the structure of a trading subnetwork (local graph) including a vector-calculation target node. To be more specific, as the vectorial representation of a node, information can be used that reflects in detail information including which of the upstream companies and which of the downstream companies the node is connected to.

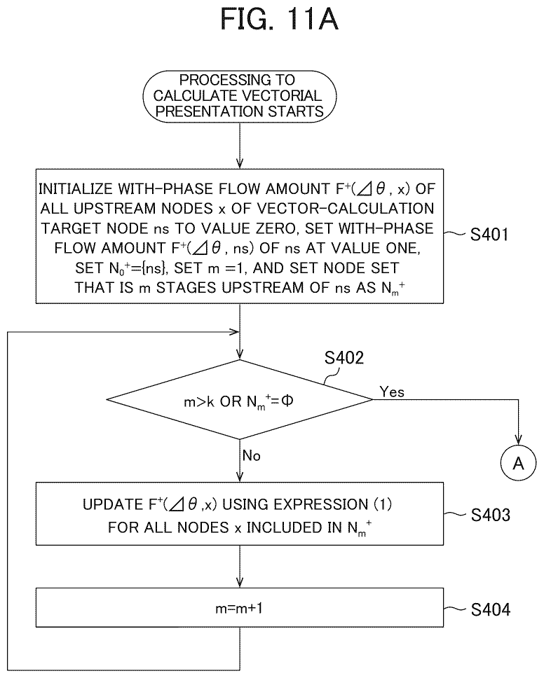

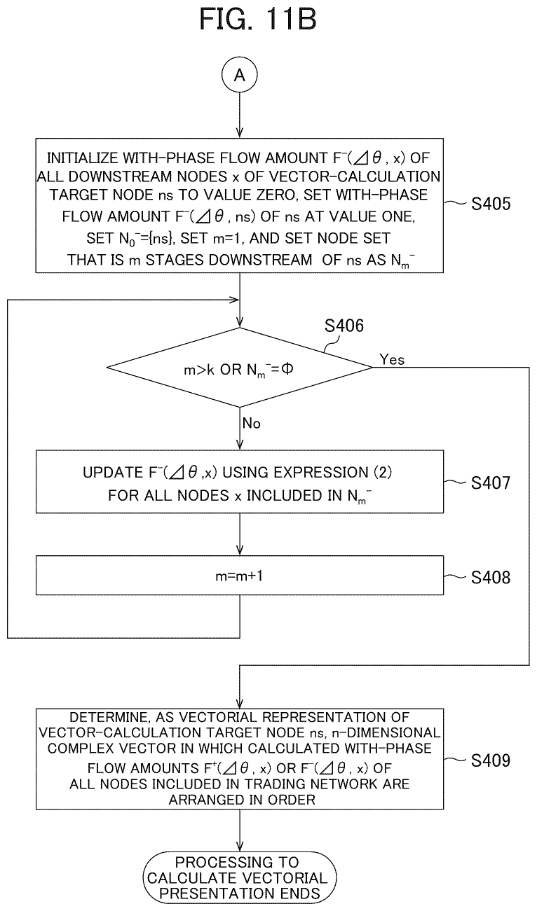

FIGS. 11A and 11B are flowcharts showing the process for determining the vectorial representation of a vector-calculation target node, which corresponds to Step S203 in FIG. 7. In Step S401, the vector obtaining unit 112 firstly executes initialization processing on an upstream node. In the following, let a node upstream of a vector-calculation target node ns be denoted as x; accordingly, the with-phase flow amount of the upstream node x is denoted as F⁺(Δθ, x). The vector obtaining unit 112 initializes F⁺(Δθ, x) to 0, for all upstream nodes x included in the trading network 121 and located upstream of the vector-calculation target node ns. The vector obtaining unit 112 also sets F⁺(Δθ, ns), which is the with-phase flow amount of the vector-calculation target node ns, at 1. Further, let a node set that is m stages upstream of a vector-calculation target node be denoted as Nₘ⁺. A node that is zero stages away from the vector-calculation target node ns is the vector-calculation target node itself and is thus denoted as N₀⁺={ns}. The vector obtaining unit 112 also initializes m to 1.

In Step S402, the vector obtaining unit 112 determines whether at least one of m>k and Nₘ⁺=φ is satisfied. For instance, k herein is, for instance, similar to the value k described in the processing to extract a trading subnetwork and is a numeric value indicating the upper-limit number of stages in a search range. Further, q denotes an empty set.

If m≤k and Nₘ⁺≠φ are satisfied (if NO in Step S402), the vector obtaining unit 112 in Step S403 updates F⁺(Δθ, x) using Expression (1) below, for all nodes x included in Nₘ⁺.

$$\\ \begin{matrix}[ Expression 1 ] & \\ {F}^{{}_{} +} ( Δ θ , x ) = {F}^{{}_{} +} ( Δ θ , x ) + {e}^{{}_{} i Δ θ} \times \{ \sum \{ ratio of distribution to edge connecting x and y \times {F}^{{}_{} +} ( Δ θ , y ) \} \} & ( 1 )\end{matrix}$$

$$\\ all nodes y connected to x in {N}_{m - 1}^{{}_{} +}$$

Specific examples will be described with refence to FIGS. 12A and 12B. FIGS. 12A and 12B illustrate an instance where the trading network 121 includes fourteen nodes in total. Herein, let a node 8 be selected as a vector-calculation target node. It is noted that the trading network 121 herein, which is small in scale and is identical to a trading subnetwork including three stages upstream of the node 8 and three stages downstream of the node 8, will not be distinguished from the trading subnetwork in the following description.

FIG. 12A illustrates the amount of flow in the trading network 121 with a focus on the node 8. In this case, nodes that are one stage upstream of the node 8 are a node 3 and a node 4. That is, there are two edges for flow from a node one stage upstream of the node 8 into the node 8: one is the edge connecting the nodes 3 and 8 together, and the other is the edge connecting the nodes 4 and 8 together. Accordingly, when the amount of flow into the node 8 is set at 1, the amount of flow is distributed to the two edges at a given ratio.

For an equal distribution ratio for instance, the amount of flow from the node 3 into the node 8 stands at ½, and the amount of flow from the node 4 into the node 8 stands at ½. As a matter of course, when there are N (N is an integer equal to or greater than two) edges for flow from a node one stage upstream of the node 8 into the node 8, the amounts of flow corresponding to the respective edges stand at 1/N. The following describes an instance where the ratio of distribution stands at an equal ratio. It is noted that when a specific product trading volume or other things is associated with an edge, the ratio of distribution may be set based on this trading volume.

Once the ratio of distribution is determined, the calculation of Expression (1) above is performed specifically. For determining F⁺(Δθ, 3) for instance, F⁺(Δθ, 3) in the first term on the right-hand side before update is an initial value per se and thus stands at 0. Further, N₀⁺ is only the node 8, and thus, the “all nodes y connected to x in Nₘ₋₁⁺” is the node 8. Further, the ratio of distribution of the edge connecting the nodes 3 and 8 together stands at ½, as earlier described. Further, F⁺(Δθ, y) denotes the with-phase flow amount of a vector-calculation target node, which is herein the node 8, and thus stands at 1 as set in Step S401. Accordingly, F⁺(Δθ, 3) is updated as indicated below. Likewise, F⁺(Δθ, 4) is updated as indicated below.

$$\\ {F}^{{}_{} +} ( Δ θ , 3 ) = 0 + {e}^{{}_{} i Δ θ} \times ( 1 / 2 ) \times 1 = 0.5 {e}^{{}_{} i Δ θ}$$

$$\\ {F}^{{}_{} +} ( Δ θ , 4 ) = 0 + {e}^{{}_{} i Δ θ} \times ( 1 / 2 ) \times 1 = 0.5 {e}^{{}_{} i Δ θ}$$

FIG. 12B illustrates an instance of the trading network 121 similar to that in FIG. 12A and illustrates, by way of example, the with-phase flow amount of each node with the node 8 selected as a vector-calculation target node. As earlier described, the with-phase flow amounts of the nodes 3 and 4 both stand at 0.5e^{iΔθ}.

In Step S404, the vector obtaining unit 112 next increments m and goes back to Step S402 to execute the processing. For instance, m=2 is set in the processing in Step S402 in the second time, and thus, a determination on whether 2>k is satisfied, and a determination on whether N₂⁺ is an empty set are made.

In k=3 for instance, 2>k is not satisfied. Further, in the examples in FIGS. 12A and 12B, there are nodes that are two stages upstream of the node 8: one is a node 1, which is one stage upstream of and adjacent to the node 3 and one stage upstream of and adjacent to the node 4; and the other is a node 2, which is one stage upstream of adjacent to the node 4. That is, N₂⁺ is not an empty set, but a set of the nodes 1 and 2. Thus, the vector obtaining unit 112 in these examples determines NO in Step S402 and executes the processing in Step S403.

In this case, the nodes 1 and 2 included in N₂⁺ undergo update of their with-phase flow amounts. As illustrated in FIG. 12A, a node that is one stage upstream of the node 3 is only the node 1. That is, there is only one edge for flow from a node that is one stage upstream of the node 3 into the node 3: the edge connecting the nodes 1 and 3 together. Thus, the flow amount of the node 3 is a flow amount resulting, in its entirety, from the node 1, and its ratio of distribution stands at 1.

Further, there are two nodes that are one stage upstream of the node 4: the nodes 1 and 2. That is, there are two edges for flow from nodes that are one stage upstream of the node 4 into the node 4: one is the edge connecting the nodes 1 and 4 together, and the other is the edge connecting the nodes 2 and 4 together. Thus, the flow amount of the node 4, which is a flow amount resulting from the node 1 by half and resulting from the node 2 by the remaining half, has a distribution ratio of ½ for each half.

Once the ratio of distribution is determined, the calculation of Expression (1) above is performed specifically. For determining F⁺(Δθ, 1) for instance, F⁺(Δθ, 1) in the first term on the right-hand side before update is an initial value per se and thus stands at 0. Further, Nit is the nodes 3 and 4, both of which are connected to the node 1; thus, the “all nodes y connected to x in Nₘ₋₁+” are two nodes, i.e., the nodes 3 and 4. Further, the ratio of distribution of the edge connecting the nodes 1 and 3 together stands at 1, and the with-phase flow amount F⁺(Δθ, 3) of the node 3 stands, as earlier described, at 0.5e^{iΔθ}. Further, the ratio of distribution of the link connecting the nodes 1 and 4 together stands at ½, and the with-phase flow amount F⁺(Δθ, 4) of the node 4 stands, as earlier described, at 0.5e^{iΔθ}. Accordingly, F⁺(Δθ, 1) is updated as indicated below.

$$\\ {F}^{{}_{} +} ( Δ θ , 1 ) = 0 + {e}^{{}_{} i Δ θ} \times \{ 1 \times 0.5 {e}^{{}_{} i Δ θ} + 1 / 2 \times 0.5 {e}^{{}_{} i Δ θ} \} = 0.75 {e}^{{}_{} 2 i Δ θ}$$

For determining F⁺(Δθ, 2), F⁺(Δθ, 2) in the first term on the right-hand side before update is an initial value per se and thus stands at 0. Further, Nit are the nodes 3 and 4, between which only the node 4 is connected to the node 2; thus, the “all nodes y connected to x in Nₘ₋₁+” is one node, i.e., the node 4. Further, the ratio of distribution of the edge connecting the nodes 2 and 4 together stands at ½, and the with-phase flow amount F⁺(Δθ, 4) of the node 4 stands, as earlier described, at 0.5e^{iΔθ}. Accordingly, F⁺(Δθ, 2) is updated as indicated below.

$$\\ {F}^{{}_{} +} ( Δ θ , 2 ) = 0 + {e}^{{}_{} i Δ θ} \times \{ 1 / 2 \times 0.5 {e}^{{}_{} i Δ θ} \} = 0.25 {e}^{{}_{} 2 i Δ θ}$$

As can be seen from the above description, e^{iΔθ} undergoes multiplication every time the number of stages counted from a vector-calculation target node increases, and thus, the phase is shifted by Δθ every time. That is, in the technique in this embodiment, a node that is m stages upstream of the vector-calculation target node has a phase of mΔθ.

In Step S404, the vector obtaining unit 112 next increments m and goes back to Step S402 to execute the processing. For instance, m=3 is set in the processing in Step S402 in the third time, and thus, a determination on whether 3>k is satisfied, and a determination on whether N₃⁺ is an empty set are made.

In the examples of the trading network 121 in FIGS. 12A and 12B, there is no node that is upstream of the node 1 and is upstream of the node 2, and thus, N₃⁺ is an empty set. The vector obtaining unit 112 thus determines YES in Step S402 and proceeds to the processing on the downstream nodes shown in FIG. 11B. If N₃⁺ is not an empty set, and if k≥3 is satisfied, the vector obtaining unit 112 determines NO in Step S402; accordingly, each of the nodes included in N₃⁺ undergoes update of its with-phase flow amount. That is, in the technique in this embodiment, the processing to update the with-phase flow amount is repeated toward upstream stages one by one until at least one of the following conditions is satisfied: k upstream stages have undergone the processing; and there is no more upstream node.

Upon completing the processing on the upstream nodes, the vector obtaining unit 112 in Step S405 in FIG. 11B executes initialization on downstream nodes. In the following, let a node downstream of the vector-calculation target node ns be denoted as x; accordingly, the with-phase flow amount of the downstream node x is denoted as F⁻(Δθ, x). The vector obtaining unit 112 initializes F⁻(Δθ, x) to 0, for all downstream nodes x included in the trading network 121 and located downstream of the vector-calculation target node ns. The vector obtaining unit 112 also sets F⁻(Δθ, ns), which is the with-phase flow amount of the vector-calculation target node ns itself, at 1. Further, let a node set that is m stages downstream of the vector-calculation target node be denoted as Nₘ⁻. A node that is zero stages away from the vector-calculation target node ns is the vector-calculation target node itself and is thus denoted as N₀⁻={ns}. The vector obtaining unit 112 also initializes m to 1.

In Step S406, the vector obtaining unit 112 determines whether at least one of m>k and Nₘ⁻=φ is satisfied. That is, like the processing on the upstream nodes, the processing is repeated on the downstream nodes until the following condition is satisfied: k stages have undergone the processing, or there is no more downstream node.

If k stages have not yet undergone the processing, and if there is a downstream node (if NO in Step S406), the vector obtaining unit 112 in Step S407 updates F⁻(Δθ, x) using Expression (2) below, for all the nodes x included in Nₘ⁻.

$$\\ \begin{matrix}[ Expression 2 ] & \\ {F}^{{}_{} -} ( Δ θ , x ) = {F}^{{}_{} -} ( Δ θ , x ) + {e}^{{}_{} - i Δ θ} \times \{ \sum \{ ratio of distribution to edge connecting x and y \times {F}^{{}_{} -} ( Δ θ , y ) \} \} & ( 2 )\end{matrix}$$

$$\\ all nodes y connected to x in {N}_{m - 1}^{{}_{} -}$$

In the example in FIG. 12A, nodes that are one stage downstream of the vector-calculation target node, i.e., the node 8, are a node 11 and a node 12. That is, there are two edges for flow from the node 8 into nodes that are one stage downstream of the node 8: one is the edge connecting the nodes 8 and 11 together, and the other is the edge connecting the nodes 8 and 12 together. Accordingly, when the amount of flow from the node 8 is set at 1, the amount of flow is distributed to the two edges at a given ratio. For an equal distribution ratio, the amount of flow from the node 8 to the node 11 stands at ½, and the amount of flow from the node 8 to the node 12 stands at ½.

Once the ratio of distribution is determined, the calculation of Expression (2) above is performed specifically. For determining F⁻(Δθ, 11) for instance, F⁻(Δθ, 11) in the first term on the right-hand side before update is an initial value per se and thus stands at 0. Further, No is only the node 8, and thus, the “all nodes y connected to x in Nₘ₋₁” is the node 8. Further, the ratio of distribution of the edge connecting the nodes 8 and 11 together stands at ½, as earlier described. Further, F⁻(Δθ, y) denotes the with-phase flow amount of the vector-calculation target node, i.e., the node 8, and thus stands at 1 as set in Step S405. Accordingly, F⁻(Δθ, 11) is updated as indicated below. Likewise, F⁻(Δθ, 12) is updated as indicated below.

$$\\ {F}^{{}_{} -} ( Δ θ , 11 ) = 0 + {e}^{{}_{} - i Δ θ} \times ( 1 / 2 ) \times 1 = 0.5 {e}^{{}_{} - i Δ θ}$$

$$\\ {F}^{{}_{} -} ( Δ θ , 12 ) = 0 + {e}^{{}_{} - i Δ θ} \times ( 1 / 2 ) \times 1 = 0.5 {e}^{{}_{} - i Δ θ}$$

In Step S408, the vector obtaining unit 112 next increments m and goes back to Step S406 to execute the processing. For instance, m=2 is set in the processing in Step S406 in the second time, and thus, a determination on whether 2>k is satisfied, and a determination on whether N₂⁻ is an empty set are made.

In the examples in FIGS. 12A and 12B, the nodes 13 and 14 included in N₂⁻ undergo the processing to update F⁻(Δθ, 13) and F⁻(Δθ, 14). The detailed processing, which is similar to the example described earlier, will not be described. It is noted that e^{-iΔθ} undergoes multiplication every time the number of stages counted from a vector-calculation target node increases, and thus, the phase is shifted by −Δθ every time. That is, in the technique in this embodiment, a node that is m stages downstream of the vector-calculation target node has a phase of −mΔθ.

If at least one of the following conditions: k downstream stages have undergone the processing; and there is no more downstream node, is satisfied (if YES in Step S406), the vector obtaining unit 112 in Step S409 determines the vectorial representation of the vector-calculation target node in accordance with the with-phase flow amount determined for each of the nodes.

To be specific, the vector obtaining unit 112 determines, as the vectorial representation of the vector-calculation target node, an n-dimensional complex vector in which the with-phase flow amounts of all n nodes included in the trading network 121 are arranged in a predetermined order.

FIG. 13 illustrates a vectorial representation in the examples described earlier with reference to FIGS. 12A and 12B. As earlier described, the trading network 121 herein includes 14 nodes, and a determined vector is a 14-dimensional complex vector. For instance, the 14-dimensional complex vector is a vector in which the with-phase flow amounts of the nodes 1 to 14 are arranged in the stated order. It is noted that the order of a plurality of nodes included in the trading network 121 is non-limiting; modifications can be made in various manners.

As earlier described, the nodes 1 to 4 and nodes 11 to 14, which are connected to the node 8 or a vector-calculation target node, undergo update of their with-phase flow amounts. Thus, the first to fourth elements and the eleventh to fourteenth elements are complex numbers that are not zero. In contrast, the nodes 5 to 7 and nodes 9 to 10 are not update targets, and thus, their with-phase flow amounts remain at an initial value, i.e., 0. Thus, the fifth to seventh elements and the ninth to tenth elements stand at 0. The eighth element, which is the with-phase flow amount of the node 8 itself, stands at 1.

The technique in this embodiment enables not only the use of a flow amount per se, but also the use of a vectorial representation reflecting the number of stages counted from a vector-calculation target node. In the example in FIG. 13, since the first element of the complex vector has a phase of 240, this complex vector can hold information indicating that the node 1 is two stages upstream of the vector-calculation target node. Likewise, since the third element has a phase of 40, the complex vector can hold information indicating that the node 3 is one stage upstream of the vector-calculation target node. By using the complex vector holding these information items in the subsequent processing, information including the number of stages is reflected to the processing, thereby enabling improvement in processing accuracy.

It is noted that in performing the processing on up to k upstream and downstream stages, the phases of a complex number constituting elements are Δθ, 2Δθ, 3Δθ, . . . , and kΔθ in the upstream stages and are −Δθ, −2Δθ, −3Δθ, . . . , and −kΔθ in the downstream stages. To clarify the relationship between phases and the number of stages, these phases do not desirably overlap each other. For instance, when k=3 is satisfied, setting Δθ=π/2 involves an overlap, such as e^{2iΔθ}=e^{-2iΔθ}=−1, thus making it difficult to distinguish, for instance, that a node is two stages upstream away from that the node is two stages downstream away. Accordingly, the value Δθ in this embodiment may be set based on k. For instance, Δθ is a positive real number satisfying (k+1)×Δθ=π.

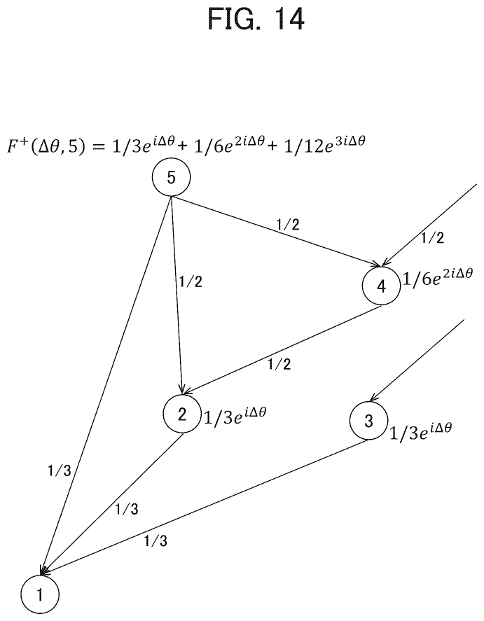

FIG. 14 illustrates part of the trading network 121 of different structure. FIG. 14 shows an instance where the node 1 is selected as a vector-calculation target node, and where the with-phase flow amounts of the nodes 2 to 5 and other nodes are determined.

The node 5 herein, which is directly connected to the node 1, is a node included in N₁⁺. To be specific, the with-phase flow amount F⁺(Δθ, 5) of the node 5 is updated as indicated below through processing targeted on N₁⁺.

$$\\ {F}^{{}_{} +} ( Δ θ , 5 ) = 0 + {e}^{{}_{} i Δ θ} \times ( 1 / 3 ) \times 1 = ( 1 / 3 ) {e}^{{}_{} i Δ θ}$$

The node 5, which is one stage upstream of the node 2 included in N₁⁺, is also a node included in N₂⁺. To be specific, the with-phase flow amount F⁺(Δθ, 5) of the node 5 is updated as indicated below through processing targeted on N₂⁺. It is noted that the with-phase flow amount F⁺(Δθ, 2) of the node 2 is (⅓)e^{iΔθ}.

$$\\ {F}^{{}_{} +} ( Δ θ , 5 ) = ( 1 / 3 ) {e}^{{}_{} i Δ θ} + {e}^{{}_{} i Δ θ} \times ( 1 / 2 ) \times ( 1 / 3 ) {e}^{{}_{} i Δ θ} = ( 1 / 3 ) {e}^{{}_{} i Δ θ} + ( 1 / 6 ) {e}^{{}_{} 2 i Δ θ}$$

Furthermore, the node 5, which is one stage upstream of the node 4 included in N₂⁺, is a node included in N₃⁺. To be specific, the with-phase flow amount F⁺(Δθ, 5) of the node 5 is updated as indicated below through processing targeted on N₃⁺. It is noted that the with-phase flow amount F⁺(Δθ, 4) of the node 4 is (⅙)e^{2iΔθ}.

$$\\ {F}^{{}_{} +} ( Δ θ , 5 ) = ( 1 / 3 ) {e}^{{}_{} i Δ θ} + ( 1 / 6 ) {e}^{{}_{} 2 i Δ θ} + {e}^{{}_{} i Δ θ} \times ( 1 / 2 ) \times ( 1 / 6 ) {e}^{{}_{} 2 i Δ θ} = ( 1 / 3 ) {e}^{{}_{} i Δ θ} + ( 1 / 6 ) {e}^{{}_{} 2 i Δ θ} + ( 1 / 12 ) {e}^{{}_{} 3 i Δ θ}$$

As described above, the technique in this embodiment can represent, by using the with-phase flow amount of a target node, a network structure in which there are multiple paths having different distances (the number of stages) measured from a vector-calculation target node to the target node. In the foregoing example for instance, F⁺(Δθ, 5) includes three phase terms, i.e., Δθ, 2Δθ, and 3Δθ, and thus, the structure of the trading subnetwork illustrated in FIG. 14 is reflected appropriately to a vectorial representation.

The complex vector of each node in the trading network 121 may be used in similarity calculation between the nodes for instance. For instance, the processing unit 110 may include a similarity calculating unit (not shown) that determines the similarity, S, between nodes i and j on the basis of Expression (3) below. In Expression (3) below, xⱼ* denotes a complex conjugate vector with conjugate complex numbers taken from individual elements of xⱼ. That is, the numerator on the right-hand side denotes the Hermitian inner product of xᵢ and xⱼ. Further, |xᵢ| and |xⱼ| respectively denote the sizes (norms) of xᵢ and xⱼ. R{ } denotes a real part.

$$\\ \begin{matrix}[ Expression 3 ] & \\ S = R \{ \frac{{x}_{i} \cdot {x}_{j}^{{}_{} *}}{\vert {x}_{i} \vert \vert {x}_{j} \vert} \} & ( 3 )\end{matrix}$$

Doing so enables cosine similarity that is used in, for instance, similarity calculation between vectors, to be extended to a complex number. Specifically, a determination by the use of the distance (phase difference) between nodes can be made, as earlier described, thereby enabling similarity calculation with high accuracy.

### 2.4 Complex Correlation Matrix and Eigenvalue Decomposition

The complex vector in this embodiment may be used in the processing to extract the supply chain network 122 from the trading network 121. Specifically, as shown in Step S103 in FIG. 4, the matrix obtaining unit 113 determines the complex correlation matrix C in accordance with the complex vector, and as shown in Step S104, the matrix obtaining unit 113 subjects the complex correlation matrix C to eigenvalue decomposition.

The matrix obtaining unit 113 firstly obtains the complex vectorial representation of each of first to n-th nodes included in the trading network 121. Hereinafter, a complex vector corresponding to the i-th (i is an integer satisfying 1≤i≤n) node will be denoted as xᵢ. For instance, the vector obtaining unit 112 selects each of the first to n-th nodes as vector-calculation target nodes and subjects them individually to the processing shown in FIGS. 11A and 11B to thus determine complex vectors x₁ to xₙ, and the vector obtaining unit 112 stores the determined x₁ to xₙ in the storage unit 120. Each of x₁ to xₙ is an n-dimensional complex vector; for instance, each is a column vector.

The matrix obtaining unit 113 next arranges x₁ to xₙ to thus obtain a matrix X. For instance, the matrix obtaining unit 113 obtains the matrix X=[x₁, x₂, . . . , xₙ], in which x₁ to xₙ are arranged in a predetermined order, and normalizes each component so that its absolute value stands at 1. The matrix obtaining unit 113 sets the matrix after the normalization anew as a matrix X. As described above, the processing of “arranging x₁ to xₙ to obtain a matrix X” in this embodiment is not limited to merely arranging x₁ to xₙ; this processing may include other kinds of processing (the processing may be pre-arrangement processing, or post-arrangement processing), such as normalization.

The matrix X is a square matrix of n rows and n columns. The matrix obtaining unit 113 also determines a matrix (complex conjugate transposition) X* in which conjugate complex numbers of the individual components of the matrix X are transposed. The matrix X* is a square matrix of n rows and n columns as well. It is noted that the order of arrangement of n nodes included in the trading network 121 is the same as the order in determining the complex vector representations.

The matrix obtaining unit 113 then determines the complex correlation matrix C through C=XX*. The complex correlation matrix C is a square matrix of n rows and n columns as well. Each component of C corresponds to the Hermitian inner product of two complex vectors and is thus information corresponding to the similarity expressed by Expression (3) above. Thus, C can be used as the complex correlation matrix C indicating the node-to-node correlation between the first to n-th nodes in the trading network 121.

The matrix obtaining unit 113 next subjects the complex correlation matrix C to eigenvalue decomposition. Specifically, the matrix obtaining unit 113 decomposes, through C=VΛV⁻¹, the complex correlation matrix C into the following: a matrix V with its eigenvector as a column vector; and a diagonal matrix Λ with its eigenvalue as a diagonal component. Hereinafter, m eigenvalues will be denoted as eᵢ to eₘ, and m eigenvectors corresponding to the respective eigenvalues will be denoted as vᵢ to vₘ. Here, m is an integer satisfying m≤n. Since the eigenvalue decomposition is a publicly known method, its detailed description will be omitted.

It is noted that although the foregoing has described an instance where x₁ to xₙ are represented as column vectors, x₁ to xₙ may be represented as row vectors. In this case, for instance, the matrix obtaining unit 113 sets, as X, a matrix in which x₁ to xₙ are longitudinally arranged, and in which their absolute values are normalized to 1. Further, the matrix obtaining unit 113 may determine the complex correlation matrix C through C=X*X. As described above, the matrix obtaining unit 113 in this embodiment performs processing to determine the complex correlation matrix C in accordance with a plurality of complex vectors, which represents respective nodes in a trading network, and processing to subject the complex correlation matrix C to eigenvalue decomposition. Their specific processing can be modified in various manners.

### 2.5 Obtainment of Supply Chain Network

Processing to extract the supply chain network 122, which corresponds to Step S105 in FIG. 4, will be described.

The supply chain extracting unit 114 performs processing to extract a supply-chain-network group in accordance a trading network and complex vectors, and processing to select a part of the supply-chain-network group including a processing target node, as the supply chain network 122 that is a target for generating a tag transition diagram. Doing so enables an important part of the trading network 121 to be extracted as the supply chain network 122 and enables processing targeted on a specific node (company) to be performed. This can appropriately prevent the amount of information that is used in the generation of the tag transition diagram.

Hereinafter, processing to extract a supply-chain-network group without company (node) limitations will be referred to as first extraction processing, and processing to extract the supply chain network 122 from the supply-chain-network group with limitations on companies, products, or other things will be referred to as second extraction processing.

### 2.5.1 Obtainment of Supply-Chain-Network Group

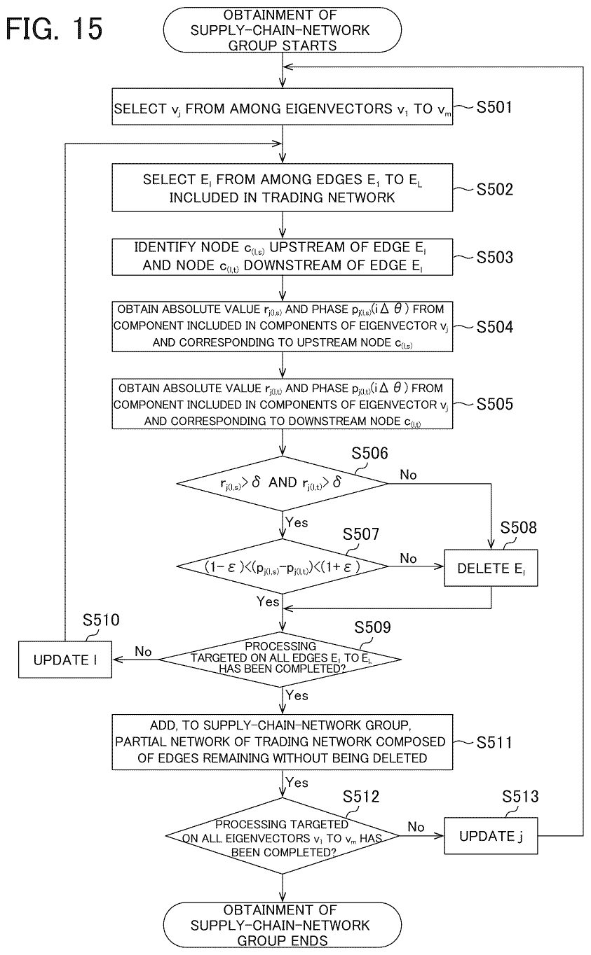

FIG. 15 is a flowchart showing the first extraction processing that is performed by the supply chain extracting unit 114. In Step S501, the supply chain extracting unit 114 firstly selects vⱼ from among m eigenvectors vᵢ to vₘ. Here, j is an integer ranging from 1 to m inclusive, and for example, its initial value is expressed as j=1.

Here, vⱼ, which is a vector obtained by subjecting the complex correlation matrix C of n rows and n columns to eigenvalue decomposition, is a column vector including n elements. For example, the eigenvector vⱼ is expressed as Expression (4) below. It is noted that for easy expression, Expression (4) below uses a transposition expression of the eigenvector vⱼ.

$$\\ \begin{matrix}[ Expression 4 ] & \\ {v}_{j}^{{}_{} T} = ( {r}_{j 1} {e}^{{}_{} {p}_{j 1} ( i Δ θ )} , {r}_{j 2} {e}^{{}_{} {p}_{j 2} ( i Δ θ )} , … , {r}_{j N} {e}^{{}_{} {p}_{j N} ( i Δ θ )} ) & ( 4 )\end{matrix}$$

Here, the first element of the eigenvector vⱼ indicates information about the node 1 in the trading network 121. That is, the node 1 has an absolute value (a flow amount) of rⱼ₁, and a phase (a distance from a reference node) of pⱼ₁. The same holds true for the second to n-th elements of the eigenvector vⱼ; each indicates the flow amount and phase of a corresponding one of the nodes 2 to n. That is, a single eigenvector is information for identifying the relationship (network structure) between n nodes included in the trading network 121. Moreover, in view that eigenvectors are determined from the complex correlation matrix C, a network structure indicated by the eigenvectors is conceivably a main network structure in the trading network 121. As such, the supply chain extracting unit 114 in this embodiment performs the first extraction processing to extract a supply-chain-network group from the trading network 121 in accordance with the eigenvectors.

In Step S502, the supply chain extracting unit 114 selects E₁ from among edges E₁ to E_{L} (L denotes the total number of edges and is an integer equal to or greater than two) included in the trading network 121. Here, 1 is an integer ranging from 1 to L inclusive, and for example, its initial value is expressed as 1=1.

In Step S503, the supply chain extracting unit 114 identifies a node c_{(1, s)} upstream of the edge E₁ and a node c_{(1, t)} downstream of the edge E₁. The edge E₁ includes, for instance, the upstream node c_{(1, s)} and downstream node c_{(1, t)} as its attribute; by referring to these attribute values, the supply chain extracting unit 114 performs the processing in Step S503.

In Step S504, the supply chain extracting unit 114 determines the absolute value, r_{j(1, s)}, and phase, p_{j(1, s)}, of the upstream node c_{(1, s)} in accordance with the eigenvector vⱼ. Specifically, the supply chain extracting unit 114 identifies in what position the upstream node c_{(1, s)} is placed among the nodes 1 to n included in the trading network 121, and the supply chain extracting unit 114 reads a corresponding one of n elements of the eigenvector vⱼ to thus determine the absolute value r_{j(1, s)} and the phase p_{j(1, s)}. For example, when the upstream node c_{(1, s)} corresponds to the node 1, r_{j(1, s)}=rⱼ₁ is established, and p_{j(1, s)}=pⱼ₁ is established.

In Step S505, the supply chain extracting unit 114 determines the absolute value, r_{j(1, t)}, and phase, p_{j(1, t)}, of the downstream node c_{(1, t)} in accordance with the eigenvector vⱼ. The specific processing is similar to that in the upstream node c_{(1, s)}.

The supply chain extracting unit 114 then extracts the supply chain network 122 by performing the following: first determination to determine the size of the flow amount of the upstream node c_{(1, s)}, and the size of the flow amount of the downstream node c_{(1, t)}, both of which are indicated by the absolute values of elements of the eigenvector vⱼ; and second determination to determine the distance between the upstream node c_{(1, s)} and downstream node c_{(1, t)}, which is indicated by the phases of the elements of the eigenvector vⱼ. It is noted that both of the first determination and second determination are not essential; either one of them may be omitted.

In this way, the degree of importance of the edge E₁ can be determined by the use of the flow amount and phase, both of which are determined from the eigenvector vⱼ. Specifically, when both of the flow amount of the upstream node c_{(1, s)} and the flow amount of the downstream node c_{(1, t)} are large to a certain extent in an eigenvector, the edge E₁ connecting these two nodes together is presumably an important edge in the trading network 121. Further, the phase determined from the eigenvector vⱼ indicates the main connection relationship (distance, the number of stages) between the upstream node c_{(1, s)} and downstream node c_{(1, t)} in the network structure indicated by this eigenvector vⱼ. That is, the importance of the edge E₁ can be determined as being high if a connection relationship identified from the phase of an eigenvector, and the connection relationship in the edge E₁ are close to each other, and the importance of the edge E₁ can be determined as being low if these relationships are far from each other. As described above, using a flow amount and a phase can make an appropriate determination on the edge E₁.

In Step S506, the supply chain extracting unit 114 performs the first determination based on the flow amount. Specifically, the supply chain extracting unit 114 determines whether the absolute value r_{j(1, s)} of the upstream node c_{(1, s)} is greater than a given threshold δ, and whether the absolute value r_{j(1, t)} of the downstream node c_{(1, t)} is greater than the given threshold δ.

If both of r_{j(1, s)} and r_{j(1, t)} are greater than 8 (if YES in Step S506), the supply chain extracting unit 114 in Step S507 performs the second determination based on the phase (distance). Specifically, the supply chain extracting unit 114 subtracts the phase p_{j(1, t)} of the downstream node c_{(1, t)} from the phase p_{j(1, s)} of the upstream node c_{(1, s)} and determines whether the subtracted value is greater than 1-ε and smaller than 1+ε. Here, ε denotes a given threshold.

The “1” included in 1+ε and 1−ε is a value indicating processing between two adjacent nodes. As described above, the upstream node c_{(1, s)} and downstream node c_{(1, t)} in the trading network 121 are two nodes directly connected together by the edge E₁, and their node-to-node distance stands at 1. That is, when the edge E₁ is important in the trading network 121, it is presumed that the upstream node c_{(1, s)} and downstream node c_{(1, t)} are directly connected together by an edge corresponding to the edge E₁ that is, their node-to-node distance, determined from the eigenvector vⱼ, stands at a value that is sufficiently close to 1, even in a network structure indicated by the eigenvector vⱼ. On the other hand, when the edge E₁ is not important in the trading network 121, it is presumed, in the network structure indicated by the eigenvector vⱼ, that the upstream node c_{(1, s)} and downstream node c_{(1, t)} are not connected together in the first place, or that their node-to-node distance stands at a value that is different from 1 as the result of their connection through an edge that is different from the edge E₁.

As such, in Step S507, the supply chain extracting unit 114 determines a difference value between the distance between the upstream node c_{(1, s)} and downstream node c_{(1, t)} determined from the eigenvector vⱼ, and the distance (to be specific, 1) between two adjacent nodes. Accordingly, the importance of the edge E₁ can be appropriately determined based on the phase.

If at least one of the flow amounts is equal to or smaller than the threshold δ (if NO in Step S506), or if the absolute value of the difference between the distance and the value 1 is equal to or greater than ε (if NO in Step S507), the importance of the edge E₁, which is a processing target, is determined as being low. Accordingly, in Step S508, the supply chain extracting unit 114 performs processing to exclude E₁ from the supply chain extracting unit 122, which is an extraction target.

On the other hand, if both of the flow amounts are greater than the threshold δ (if YES in Step 506), and if the absolute value of the difference between the distance and the value 1 is smaller than ε (if YES in Step 507), the edge E₁ is left as an edge constituting the supply chain network 122.

The processing targeted on the edge E₁ is thus completed. In Step S509, the supply chain extracting unit 114 determines whether the processing targeted on all the edges E₁ to E_{L} included in the trading network 121 has been completed.

If there is an unprocessed edge (if NO in Step S509), the supply chain extracting unit 114 in Step S510 updates the variable 1 and then goes back to Step S502. For instance, the supply chain extraction unit 114 subjects the edge E₁ to the processing, followed by incrementing the value 1 to update the value 1 to 2, followed by subjecting the edge E₂ to the foregoing processing in Steps S502 to S509.

If the processing targeted on all the edges has been completed (if YES in Step S509), the supply chain extracting unit 114 in Step S511 adds a network composed of some of the edges E₁ to E_{L} remaining without being excluded in the processing in Step S508, to the supply-chain-network group. The network that is added herein is a partial network of the trading network 121. It is noted that the network composed of some of the edges E₁ to E_{L} remaining without being excluded in the processing in Step S508 does not necessarily constitutes a graph in which all nodes are connected; this network may be divided into several networks. The supply chain extracting unit 114 in this case performs processing to add such individual divided networks to the supply-chain-network group.

Through the processing in Steps S501 to S511, the extraction of the supply chain network 122 targeted on the eigenvector vⱼ is completed. In Step S512, the supply chain extracting unit 114 next determines whether the processing targeted on all the eigenvectors v₁ to vₘ determined through the eigenvalue decomposition has been completed.

If there is an unprocessed eigenvector (if NO in Step S512), the supply chain extracting unit 114 in Step S513 updates the variable j and then goes back to Step S501. For instance, the supply chain extraction unit 114 subjects the eigenvector v₁ to the processing, followed by incrementing j to update j to 2, followed by subjecting the eigenvector v₂ to the foregoing processing in Steps S502 to S513. It is noted that in updating an eigenvector that is to be processed, the processing result in Step S508 undergoes initialization as well, and the processing in Step S502 starts again with all of the edges E₁ to E_{L} undeleted.

If the processing targeted on all the eigenvectors has been completed (if YES in Step S512), the supply chain extracting unit 114 ends the first extraction processing to extract the supply-chain-network group. That is, the supply-chain-network group is a set of partial networks determined for the respective eigenvectors v₁ to vₘ.

### 2.5.2 Selection of Supply Chain Network

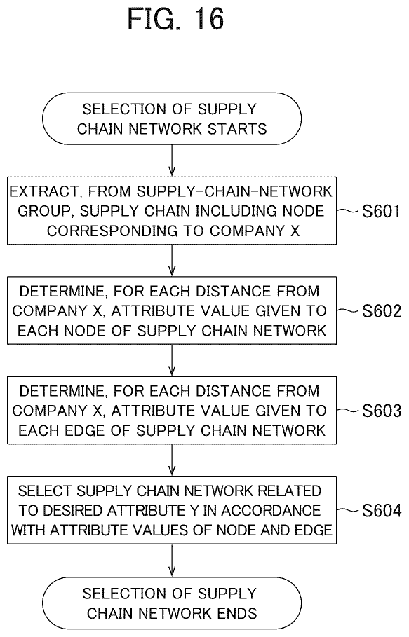

The second extraction processing to extract, from a supply-chain-network group, the supply chain network 122 related to a specific company and a specific product (including materials, raw materials, and other things). FIG. 16 is a flowchart showing the second extraction processing.

In Step S601, the supply chain extracting unit 114 extracts the supply chain network 122 including a node corresponding to a given company X, from the supply-chain-network group determined through the first extraction processing shown in FIG. 15. Here, the given company X may be input by the use of the operation unit 250 of the terminal device 200. For instance, the user of the terminal device 200 performs an operation to select, as a company X, a target company that requires some kind of analysis, such as the target company itself, a competitor, or a company to be bought out. The supply chain extracting unit 114 identifies a node X corresponding to the company X and determines whether each network included in the supply-chain-network group includes the node X.

In this embodiment, the supply chain network 122, which is the processing result in Step S601, may undergo tag-transition-diagram display, which will be described later on, and other processing. It is noted that when the company X manufactures various products, in particular, when the company X pursues a diversification strategy in different industry sectors, there are many supply chain networks 122 corresponding to the company X, thereby possibly increasing a user's viewing burden. Thus, the supply chain extracting unit 114 in this embodiment may perform processing to extract the supply chain network 122 related to a product Y. Here, the given product Y may be input by the use of the operation unit 250 of the terminal device 200.

Specifically, in accordance with a tag provided to a node included in the supply chain network 122, the supply chain extracting unit 114 in Step S602 determines the statistic of the tag for each distance from a processing target node. As earlier described, the tag provided to the node includes attributes, including an industrial classification, an address, a sales scale, a product, and a reputation (e.g., with or without a problem in view of the ESG, and with or without a sanction), and the attribute values of the respective attributes. The supply chain extracting unit 114 reads a product-related attribute value in the tag and determines the reading result for each distance from the company X. For instance, the supply chain extracting unit 114 may determine, for each distance, a product category appeared most frequently, or the supply chain extracting unit 114 may determine the number or ratio of nodes associated with this product category. Further, although an instance where a product is used is described herein, the supply chain network 122 may be extracted by the use of an attribute other than a product. That is, the product Y herein can be extended to an attribute Y other than a product.

In Step S603, the supply chain extracting unit 114 determines the statistic of the tag for each distance from the processing target node, in accordance with the tag provided to the edge included in the supply chain network 122. As earlier described, the tag provided to the edge includes attributes, including a start company, an end company, and a product as well as its price and the amount (number) of trading, and attribute values of the respective attributes. The processing to determine a statistic for each distance is similar to the processing related to a node in Step S602.

In Step S604, the supply chain extracting unit 114 extracts the supply chain network 122 related to the product Y, in accordance with the information determined in Steps S602 and S603. For instance, the supply chain extracting unit 114 determines the target supply chain network 122 as an extraction target when there is a distance in which the product Y appears most frequently in Steps S602 and S603. Alternatively, reference is made to an instance where the product Y is a material for the company X, and where it is known that the product Y is supplied from a company upstream of the company X. The supply chain extracting unit 114 in this case may determine the target supply chain network 122 as an extraction target when, in Steps S602 and S603, the product Y appears most frequently within a predetermined distance upstream of the company X.

Further, both of the processing in Step S602 and the processing in Step S603 are not essential; the supply chain network 122 related to the product Y may be extracted based of either one of them.

### 2.6 Generation of Tag Transition Diagram

Through the foregoing processing, the supply chain network 122 that is conceivably important for the user of the terminal device 200 is extracted (Step S105 in FIG. 4). Processing to generate a tag transition diagram, which corresponds to Step S106 in FIG. 4, will be detailed.

### 2.6.1 Determination of Weight for Each Transition Pattern

The tag-transition-diagram generating unit 115 determines a weight for each of a plurality of transition patterns, each indicating the transition of a tag on a path in the supply chain network 122, in accordance with a flow amount in the supply chain network 122, and the tag-transition-diagram generating unit 115 generates a tag transition diagram in accordance with the weights of the plurality of transition patterns. The tag transition patterns herein are information indicating, for instance, how the attribute value of a given attribute has changed or the attribute value has not changed in a plurality of nodes along a path on a supply chain network. The tag transition diagram can illustrate an attribute change along a path on the supply chain network 122; thus, the overview of the whole supply chain network 122 can be presented. In the generation of the tag transition diagram, the supply chain network 122 is targeted, rather than the whole trading network 121, thereby enabling easy-to-understand display with the amount of information reduced.

It is noted that the tag herein may include information indicating an industrial classification. For instance, the attribute included in the tag is an industrial classification, and its attribute value is an industrial classification code. In this case, the tag transition diagram based on the supply chain network 122 visually illustrates which industrial classification and which industrial classification are linked together by how much weight. As such, the structure (e.g., linking between industry sectors) of the supply chain network 122 can be presented in an easy-to-understand manner. It is noted that in the following description, an attribute other than an industrial classification may be used as an attribute included in the tag. That is, the tag transition diagram may a diagram showing the relationship of an attribute other than an industrial classification.

A process for generating a tag transition diagram from the supply chain network 122 will be described below.

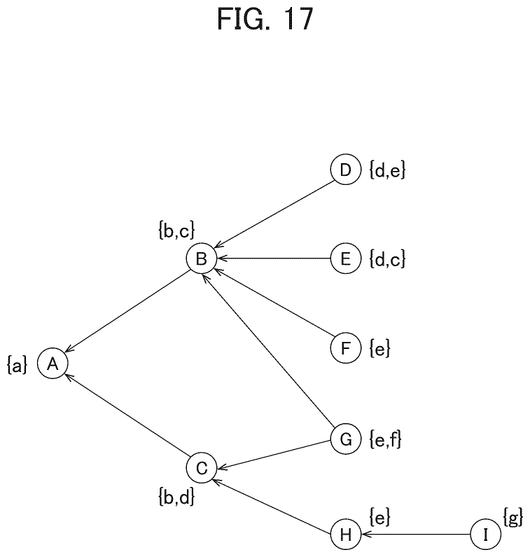

FIG. 17 illustrates an example of the supply chain network 122 that is a target for generating a tag transition diagram. Herein, the supply chain network 122 of simple configuration including nine nodes, i.e., nodes A to I will be described. Here, a to g denote tags (attribute values) associated with the respective nodes. For instance, the node A is associated with a as an industrial classification. Further, since a single company runs multiple business enterprises in some cases, a plurality of industrial classifications may be associated with a single node. For instance, the node B is associated with b and c as industrial classifications. The same holds true for the nodes C to I; a tag including one or more industrial classifications is provided to each of them.

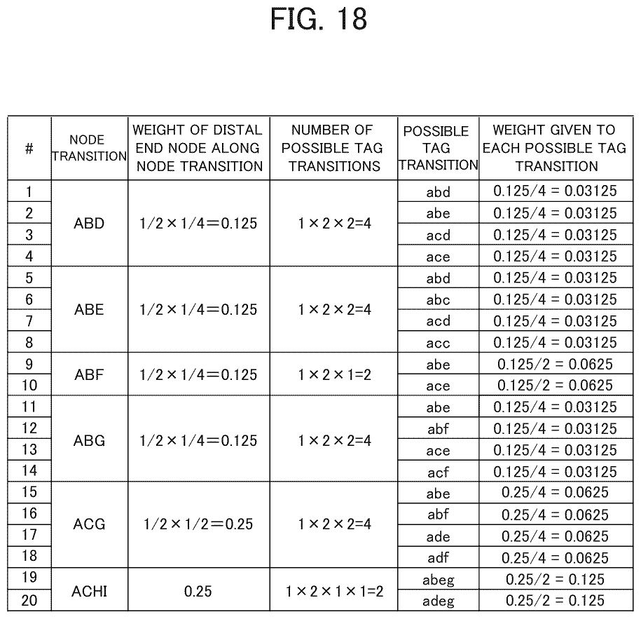

FIG. 18 is a table showing downstream-to-upstream node transitions in the supply chain network 122 in FIG. 17, and showing the weights in the respective transitions. For instance, in the supply chain network 122 in FIG. 17, the node A is the downstream end, and the nodes D, E, F, G, and I are upstream ends.

Here, there is one path of transition from the node A to the node D: the node A→the node B→the node D. Hereinafter, such a node transition will be simply referred to as ABD. In addition, there is one path of transition from the node A to the node E: ABE. There is one path of transition from the node A to the node F: ABF. There are two paths of transition from the node A to the node G: ABG and ACG. There is one path of transition from the node A to the node I: ACHI. There are six node transitions as described above.

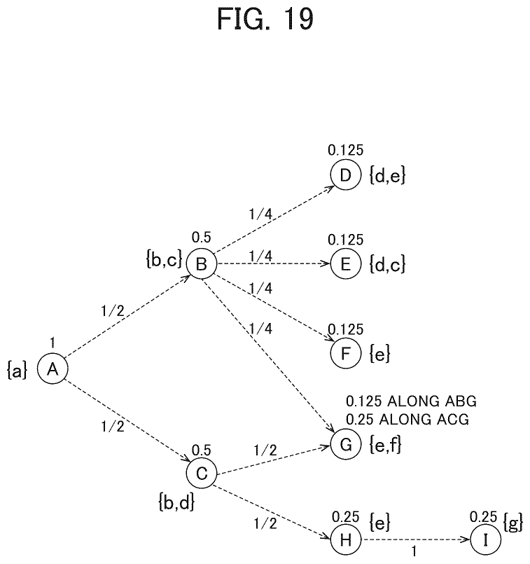

The tag-transition-diagram generating unit 115 determines the weight of each of them. FIG. 19 illustrates weights, that is, flow amounts based on the structure of the supply chain network 122. Let the flow amount of the node A be set at 1 for instance; accordingly, the node A is connected to the nodes B and C. When the flow amount is divided into equal amounts, the flow amount of the node B stands at 0.5, which is a half of the flow amount of the node A, i.e., 1. Likewise, the flow amount of the node C also stands at 0.5.

Further, the node B is connected to the node D, the node E, the node F, and the node G. Thus, the flow amount of the node B, i.e., 0.5 is distributed to these four nodes. Accordingly, the flow amount of each node stands at 0.5×(¼)=0.125.

Further, the node C is connected to the node G and the node H. Thus, the flow amount of the node C, i.e., 0.5 is distributed to these two nodes. Accordingly, the flow amount of each node stands at 0.5×(½)=0.25.

The node H is connected to only the node I. Thus, the flow amount of the node H, i.e., 0.25 is distributed to the node I as it is, and thus, the flow amount of the node I stands at 0.25.

As shown in FIG. 18, the flow amount at a distal end (upstream end) is assigned as the weight of each of ABD, ABE, ABF, ABG, ACG, and ACHI, all of which are node transitions. Referring to ABD, the upstream end is the node D, and hence, 0.125, which is the flow amount on the path from the node A through the node B to the node D, is associated. The same holds true for the other transitions. It is noted that referring to the node G, the weight is set separately for ABG and ACG.

Reference is next made to tags (attributes) given to the nodes. Referring to the node transition ABD, the attribute of the node A is only a, the attributes of the node B are b and c, and the attributes of the node C are d and e. That is, there are four possible tag transition patterns along the path ABD: abd, abe, acd, and ace. The same holds true for the other node transitions: for ABE, four possible transition patterns; for ABF, two possible transition patterns; for ABG, four possible transition patterns; for ACG, four possible transition patterns; and for ACHI, two possible transition patterns.

The tag-transition-diagram generating unit 115 determines the weight of each of the foregoing 20 transition patterns (#1 to #20 in FIG. 18). For instance, the tag-transition-diagram generating unit 115 divides a weight given to a node transition equally into each of tag transition patterns that are conceivable for the node transition, to thus determine the weight of the tag transition pattern. For instance, there are four possible tag transition patterns along the path ABD: abd, abe, acd, and ace, as earlier described. Moreover, the weight of ABD stands at 0.125, as earlier described. The tag-transition-diagram generating unit 115 in this case divides 0.125 into quarters to thus assign a weight of 0.03125 to each of abd, abe, acd, and ace, which respectively correspond to tag transition patterns #1 to #4. The same holds true for each of #5 to #20.

Here, FIG. 18 shows an instance where the nodes D and E are both associated with d as their attributes. Thus, with regard to nodes, the path ABD and the path ABE are different paths, whereas with regard to tags, the same transition pattern conceivably appears in ABD and ABE in some cases. Specifically, the tag transition pattern abd appears in both #1, corresponding to ABD, and #5, corresponding to ABE. The same holds true for the others; duplicate tag transition patterns are included in some of #1 to #20 in FIG. 18. Accordingly, the tag-transition-diagram generating unit 115 performs processing to determine the weight of each tag transition pattern by consolidating such duplicate tag transition patterns.

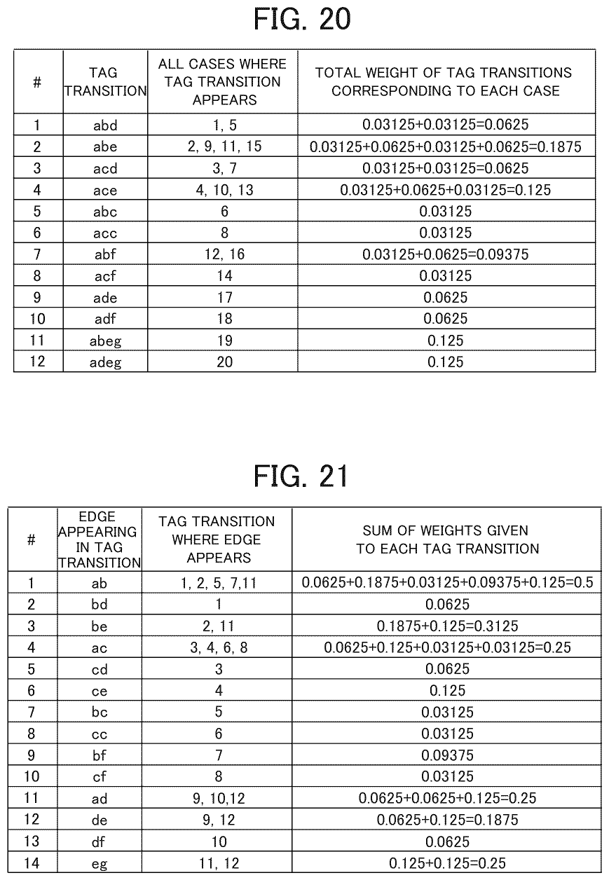

FIG. 20 illustrates consolidating tag transition patterns. For instance, the tag transition pattern abd appears in both #1 and #5, as earlier described. Accordingly, the tag-transition-diagram generating unit 115 adds, as the weight of abd, 0.03125, which is the weight of #1, and 0.03125, which is the weight of #5. The tag-transition-diagram generating unit 115 thus sets the weight of abd at 0.0625.

In addition, the tag transition pattern abe appears in #2, #9, #11, and #15 in FIG. 18. Accordingly, the tag-transition-diagram generating unit 115 adds weights corresponding to these four, to thus set the weight of abe at 0.1875. The same holds true for the others; in the example of the supply chain network 122 in FIG. 17, there are 12 patterns of tag transition from a downstream end and to an upstream end, as illustrated in FIG. 20, each of which undergoes weight determination.

The tag-transition-diagram generating unit 115 next determines an adjacent-tag transition pattern, which is a tag transition pattern between two adjacent nodes. A tag transition pattern that is used in a tag transition diagram may be an adjacent-tag transition pattern in a narrow sense.

FIG. 21 illustrates determining an adjacent-tag transition pattern. For instance, the tag transition pattern abd includes two patterns, i.e., an adjacent-tag transition pattern ab, and an adjacent-tag transition pattern bd. In addition, the tag transition pattern abe includes two patterns, i.e., the adjacent-tag transition pattern ab, and an adjacent-tag transition pattern be. The tag-transition-diagram generating unit 115 subdivides the 12 tag transition patterns determined in FIG. 20, to thus determine the weights of adjacent-tag transition patterns.

For instance, the tag-transition-diagram generating unit 115 identifies those including the adjacent-tag transition pattern ab, from among patterns of tag transition from a downstream end to an upstream end. In the example in FIG. 20, the applicable patterns are abd in #1, abe in #2, abc in #5, abf in #7, and abeg in #11. This corresponds to the column “TAG TRANSITION WHERE EDGES APPEAR” in FIG. 21. The tag-transition-diagram generating unit 115 in this case performs processing to add the weights of the five respective tag transition patterns abd, abe, abc, abf, and abeg, as the weight of the adjacent-tag transition pattern ab. Accordingly, the weight of the adjacent-tag transition pattern ab is set at 0.5.

In the example of the supply chain network 122 in FIG. 17, there are 14 adjacent-tag transition patterns, as shown in FIG. 21; for each of them, the tag-transition-diagram generating unit 115 similarly adds the weights of tag transition patterns including a target adjacent-tag transition pattern, to thus determine a weight.

### 2.6.2 Processing to Display Tag Transition Diagram and Others

The tag-transition-diagram generating unit 115 generates a tag transition diagram in accordance with the weight of an adjacent-tag transition pattern determined through the foregoing processing. The supply chain network 122 in FIG. 17 includes the attributes (industrial classifications) a to g, as earlier described. Moreover, among these attributes, weights are set for the 14 transition patterns shown in FIG. 21. Accordingly, the tag-transition-diagram generating unit 115 generates a Sankey diagram based on these information items as the tag transition diagram.

FIG. 22 is an example of a Sankey diagram, which is a tag transition diagram corresponding to the supply chain network 122 in FIG. 17. In a Sankey diagram, attributes are coupled together through a line (strip-shaped display object) having a width, and the line's width is determined by the weight of a transition pattern. For instance, a strip corresponding to a→b in FIG. 22 corresponds to the adjacent-tag transition pattern ab and thus has a width equivalent to 0.5. Displaying the Sankey diagram illustrated in FIG. 22 enables the overview of the supply chain network 122 related to the product Y of the company X to be presented in an easy-to-understand manner. It is conceivable that the supply chain network 122 actually includes more nodes than those in the example in FIG. 17. However, even in this case, a transition is displayed in the unit of tags (attributes, industrial classifications in a narrow sense), rather than in the unit of nodes, thus preventing excessively complicated information.

For instance, the information processing system 10 includes a display processing unit, not shown; this display processing unit controls the display unit 240 of the terminal device 200 to display a tag transition diagram. Doing so enables the overview of the supply chain network 122 of the company X to be presented to the user of the terminal device 200 who has requested to see the information about the company X, in an easy-to-understand manner.

Further, in response to an operation to select, as selected transition patterns, some of a plurality of transition patterns included in the tag transition diagram, the subnetwork extracting unit 116 may extract some networks shown by the selected transition patterns, as subnetworks from the supply chain network 122. For instance, the operation unit 250 of the terminal device 200 receives a user's selection operation on a tag transition diagram.

For instance, the display processing unit may display the tag transition diagram including texts or other things showing such adjacent-tag transition patterns as illustrated in FIG. 22. Further, the texts or other things showing the adjacent-tag transition patterns may be displayed in response to a pointer placed in a corresponding location within the tag transition diagram. The user of the terminal device 200 selects transition patterns by using the operation unit 250, such as a pointing device.

The transition patterns selected herein may be a set of all patterns of transition from a downstream end to an upstream end, or some of the patterns. For instance, this selected transition pattern may be such a transition pattern as abd, or such an adjacent-tag transition pattern as ab or bd. Alternatively, only two or more attribute values included in transition patterns may be designated, and a transition pattern including these attribute values may be selected automatically. Let the user input a combination of attribute values a and d for instance; accordingly, the subnetwork extracting unit 116 may determine a transition pattern in which ad as in ad, abd, acd, or others constitutes the pattern's endpoint, automatically as a selected transition pattern.

FIG. 23 illustrates an example of the subnetwork extracting unit 116 when the selected transition patterns are ad and abd. The subnetwork extracting unit 116 in this case extracts a node transition A→B→D, which corresponds to abd, and a node transition A→B→E. The subnetwork extracting unit 116 also extracts a node transition A→C, which corresponds to ad. The subnetwork extracting unit 116 then extracts a network composed of the extracted node transitions as a subnetwork of the supply chain network 122.

For instance, the display processing unit of the information processing system 10 controls the display unit 240 of the terminal device 200 to display the subnetwork. Consequently, in response to an operation to input selected transition patterns in a Sankey diagram, a detailed network structure corresponding to the selected transition patterns can be presented to the user. This enables a part of the supply chain network 122 particularly focused on by the user to be extracted and presented as a subnetwork.

This embodiment has been detailed as described above. A person skilled in the art will readily appreciate that many modifications are possible without substantially departing from the new matter and advantageous effects of the present embodiment. Accordingly, all such modifications are included in the scope of the present disclosure. For instance, terms appeared at least once in the Specification or in the drawings along with other broader or synonymous terms can be replaced with the other broader or synonymous terms in any part of the Specification or the drawings. Further, all combinations of this embodiment and its modifications are encompassed in the scope of the present disclosure. Furthermore, the configurations and operations of the information processing system, server system, terminal device, and others are not limited to those described in this embodiment; their modifications are possible in various manners.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An information processing system comprising:
a trading network obtaining unit configured to obtain a trading network in which a plurality of nodes corresponding one-to-one to a plurality of companies are connected together by an edge indicating a trading relationship;
a vector obtaining unit configured to select any one of the plurality of nodes as a vector-calculation target node, and to determine, for each of the plurality of nodes, a complex vector by assigning a complex number, the complex vector representing a relationship of the vector-calculation target node with another one of the plurality of nodes, the complex number having a phase corresponding to a distance to the vector-calculation target node, and an absolute value corresponding to an amount of flow going to or coming from the vector-calculation target node;
a supply chain extracting unit configured to extract a supply chain network in accordance with the complex vector indicating each of the plurality of nodes, the supply chain network being a part of the trading network; and
a tag-transition-diagram generating unit configured to generate a tag transition diagram in accordance with a tag given to nodes included in the supply chain network of the plurality of nodes, the tag transition diagram showing information about the tag in the supply chain network.

2. The information processing system according to claim 1, wherein
in accordance with the amount of flow in the supply chain network, the tag-transition-diagram generating unit determines a weight for each of a plurality of transition patterns each indicating a transition of the tag on a path of the supply chain network, and
the tag-transition-diagram generating unit generates the tag transition diagram in accordance with the weights of the plurality of transition patterns.

3. The information processing system according to claim 2, further comprising
a subnetwork extracting unit configured to extract a network as a subnetwork from the supply chain network in response to an operation to select, as a selected transition pattern, a part of the plurality of transition patterns included in the tag transition diagram, the network being shown by the selected transition pattern.

4. The information processing system according to claim 1, wherein
the supply chain extracting unit performs processing to extract a supply-chain-network group in accordance with the trading network and the complex vector, and
the supply chain extracting unit performs processing to select a part of the supply-chain-network group including a processing target node, as the supply chain network that is a target for generating the tag transition diagram, the processing target node being included in the plurality of nodes.

5. The information processing system according to claim 4, wherein the supply chain extracting unit determines a statistic of the tag for each of a distance from the processing target node in accordance with the tag given to the nodes included in the supply chain network.

6. The information processing system according to claim 1, wherein
the plurality of nodes include first to n-th nodes, where n is an integer of two or greater,
the complex vector corresponding to the i-th node is denoted by xᵢ, where i is an integer satisfying 1≤i≤n,
the information processing system further comprises a matrix obtaining unit configured to determine a matrix X that is obtained by arranging the complex vectors corresponding to the first to n-th nodes, to determine a matrix X* in which conjugate complex numbers of individual components of the matrix X are transposed, and to determine a complex correlation matrix C through C=XX* or C=X*X, and
the supply chain extracting unit extracts the supply chain network in accordance with an eigenvector determined through eigenvalue decomposition of the complex correlation matrix C.

7. The information processing system according to claim 6, wherein
the supply chain extracting unit extracts the supply chain network by determining a distance between an upstream node and a downstream node indicated by the phase of an element of the eigenvector, the upstream node being connected upstream of the edge included in the trading network, the downstream node being connected downstream of the edge.

8. The information processing system according to claim 7, wherein
the supply chain extracting unit extracts, as the supply chain network, a network composed of the edge determined that a difference value between the distance between the upstream node and the downstream node determined based on the eigenvector, and a distance between two of the plurality of nodes adjacent to each other is less than a threshold.

9. The information processing system according to claim 6, wherein
the supply chain extracting unit extracts the supply chain network by performing first determination to determine a size of a flow amount of an upstream node and a size of a flow amount of a downstream node each indicated by the absolute value of an element of the eigenvector, and by performing second determination to determine a distance between the upstream node and the downstream node indicated by the phase of the element of the eigenvector, the upstream node being connected upstream of the edge in the trading network, the downstream node being connected downstream of the edge.

10. The information processing system according to claim 1, wherein the tag includes information indicating an industrial classification.

11. A method of information processing that is performed by an information processing system, the method comprising:
obtaining a trading network in which a plurality of nodes corresponding one-to-one to a plurality of companies are connected together by an edge indicating a trading relationship;
selecting any one of the plurality of nodes as a vector-calculation target node, and determining, for each of the plurality of nodes, a complex vector by assigning a complex number, the complex vector representing a relationship of the vector-calculation target node with another one of the plurality of nodes, the complex number having a phase corresponding to a distance to the vector-calculation target node, and an absolute value corresponding to an amount of flow going to or coming from the vector-calculation target node;
extracting a supply chain network in accordance with the complex vector indicating each of the plurality of nodes, the supply chain network being a part of the trading network; and
generating a tag transition diagram in accordance with a tag given to nodes included in the supply chain network of the plurality of nodes, the tag transition diagram showing information about the tag in the supply chain network.
